(19) United States
(12) Patent Application Publication
(10) Pub. No.: US 2010/0008688 A1
(43) Pub. Date: Jan. 14, 2010

(54) METHOD FOR ALIGNING TRANSFER POSITION OF TRANSFER SYSTEM

(75) Inventor: Nobuki Kimura, Tokyo (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/441,415

(22) PCT Filed: Dec. 19, 2007
(86) PCT No.: PCT/JP2007/074421

§ 371 Date: Mar. 16, 2009

(30) Foreign Application Priority Data
Jan. 22, 2007 (JP) 2007-011327

(51) Int. Cl. G03G 15/16

(52) U.S. Cl. 399/66

(57) ABSTRACT

Performed is a process of obtaining, when a dummy wafer is transferred between a orienter and a second processing chamber through a transfer path, a coordinate system for correcting a position deviation by calculating a position deviation direction of a transfer position in the orienter corresponding to a direction along which the correction of the position deviation of a transfer position in the second processing chamber can be made; detecting a position deviation of the dummy wafer, after returning it back from the second processing chamber into the orienter through the transfer path, from a position where the dummy wafer was placed before transferring it from the orienter to the second processing chamber through a reference transfer path; correcting the transfer position in the second processing chamber by the transfer path based on the coordinate system for correcting the position deviation so as to reduce the detected position deviation.

### TECHNICAL FIELD

The present invention relates to a method for adjusting a transfer position of a transfer system which transfers a target object to be transferred.

### BACKGROUND

A substrate processing apparatus for performing a preset process such as dry etching, sputtering, chemical vapor deposition (CVD) or the like on a substrate, e.g., a flat panel display (FPD) substrate such as a liquid crystal substrate, or a semiconductor wafer (hereinafter, simply referred to as “wafer”) includes a processing unit having a plurality of processing chambers for performing the preset process on, e.g., the wafer; and a transfer unit for loading and unloading the wafer to and from the processing unit.

As for a substrate processing apparatus of a cluster tool type, the processing unit is comprised of a common transfer chamber having a polygonal cross section; and a plurality of modules including a multiplicity of processing chambers and load lock chambers arranged around and air-tightly connected with the common transfer chamber, and so forth. Further, the transfer unit includes an inlet port in which a wafer receptacle (cassette vessel) is installed; and an inlet side transfer chamber for loading and unloading the wafer between the cassette vessel and the processing unit. Each of the common transfer chamber and the inlet side transfer chamber includes a transfer mechanism for automatically transferring the wafer between the processing chambers, and between the cassette vessel and the processing chamber, respectively.

In the substrate processing apparatus as described above, when performing the preset process on, e.g., a wafer contained in the cassette vessel, a non-processed wafer is first unloaded from the cassette vessel by the transfer mechanism within the inlet side transfer chamber. The non-processed wafer unloaded from the cassette vessel is loaded into a position adjusting mechanism (e.g., an orienter or a pre-alignment stage), which is installed in the inlet side transfer chamber, to be aligned therein before loaded into the load lock chamber. The aligned non-processed wafer is unloaded from the position adjusting mechanism and then loaded into the load lock chamber.

The non-processed wafer loaded into the load lock chamber is unloaded from the load lock chamber by the transfer mechanism within the common transfer chamber and then loaded into the processing chamber to be subjected to the preset process. Then, after the process in the processing chamber is completed, the processed wafer is sent back to the cassette vessel through, for example, the same path as taken when it is loaded.

However, in this type of substrate processing apparatus, there is installed a single or a plurality of transfer mechanisms, and the wafer is delivered or transferred by these transfer mechanisms automatically. These transfer mechanisms include an arm configured to be extendable/retractable, revolvable and vertically movable, and carries the wafer to a predetermined module such as the processing chamber while holding the wafer by a pick at a leading end of the arm, and then finally transfers the wafer to a preset transfer position (e.g. on a mounting table) within the module.

Such transfer mechanism is required to properly hold and transfer a wafer located in a certain position to a target place and further to deliver the wafer to a transfer position in the target place with a high accuracy. Further, the wafer or the arm needs to be adjusted not to contact any component inside the substrate processing apparatus. Accordingly, when assembling the apparatus or performing a remodeling of the apparatus, a so-called teaching operation is performed wherein important positions, such as places where a delivery of the wafer is performed along the moving route of the pick of the transfer mechanism or places that the arm has to pass through to avoid an obstacle, are stored as transfer position coordinates in a controller for controlling the operation of the transfer mechanism.

The teaching operation is performed for every pick with respect to all places (modules) inside the substrate processing apparatus where the delivery of the wafer is carried out between picks, such as the cassette vessel, the mounting table of the load lock chamber, the mounting table of the position adjusting mechanism, a susceptor of each processing chamber and so forth.

In a teaching method (transfer position adjusting method) of a transfer system in the cluster tool-type substrate processing apparatus, there is used a position adjusting dummy wafer made up of a transparent plate having the same diameter and substantially the same thickness as the wafer to be transferred. A mark corresponding to, for example, an outline of the pick or the like is previously formed at a dummy wafer's appropriate position to be held by the pick. When the dummy wafer is sustained on the appropriate position of the pick, it is mounted and held while the mark on the dummy wafer coincides with the outline of the pick

To elaborate, the transfer position coordinates are temporarily set with a low accuracy (e.g., with a transfer error of about ±2 mm) only to the extent that the dummy wafer is prevented from colliding with an inside wall or the like even when the dummy wafer is transferred automatically. Subsequently, the dummy wafer is appropriately mounted on a transfer position (e.g., on the mounting table of the load lock chamber, on the susceptor of a vacuum processing chamber or the like) of each module with a high positional accuracy by manually performing position alignment thereof. Then, the dummy wafer is transferred by the pick into the orienter serving as a positioning mechanism. In the orienter, a position deviation amount is measured. The transfer position coordinates set temporarily are corrected to reduce the position deviation amount, and the corrected transfer position coordinates are stored in the control unit and finally decided.

However, with the above-described method, an operator has to perform the transfer position alignment by carefully watching and manipulating the pick manually for all of the places which the pick accesses inside the substrate processing apparatus. Therefore, it takes a long time to perform the teaching operation, which imposes a great burden on the operator.

Accordingly, there has been developed a transfer position adjusting method capable of minimizing the number of places where the operator has to manually adjust the transfer position (see, for example, Patent Document 1). For example, as for a cluster tool-type substrate processing apparatus including a transfer mechanism with two picks, in a common transfer chamber, accessible to each processing chamber serving as a processing module; and two load lock chambers serving as a transit module on the way to the processing module, there are four transfer paths to reach each processing module: four combinations of one of the two picks installed at the transfer mechanism in the common transfer chamber and one of the two transit modules, so that transfer positions on the four transfer paths are finally decided in a teaching operation. In such case, if transfer positions for one transfer path have been manually adjusted, that transfer path is used as a reference transfer path, so that transfer positions for the rest transfer paths can be automatically adjusted to coincide with the transfer positions for the reference transfer path. Accordingly, the time taken for the teaching operation can be reduced, compared to conventional cases.

Patent Document 1: Japanese Patent Laid-open Publication No. 2004-174669

### DISCLOSURE OF THE INVENTION

### Problems to Be Solved by the Invention

Meanwhile, since a transfer position deviation (for example, a position deviation amount from the center of a wafer or a position deviation direction) occurring in such modules as a processing chamber, a load lock chamber, and the like was assumed to be always coincident with a transfer position deviation occurring in a position adjusting mechanism, correction of the position deviation has been conventionally made based on this assumption.

Actually, however, it was proved from experiments that the deviation or the transfer position in the module does not always coincide with the deviation of the transfer position in the position adjusting mechanism. For example, if an installation angle or position of the module such as the processing chamber or the load lock chamber is deviated from a designed installation angle or position, a deviation direction of the transfer position in the module is not coincident with a deviation direction of the transfer position in the position adjusting mechanism. Furthermore, since the relationship between the two depends on an assembling accuracy of the substrate processing apparatus such as an installation accuracy of each module, there may occurs some non-uniformity between substrate processing apparatuses.

Therefore, if the correction is made based on the premise that the deviation of the transfer position in the module is always coincident with the deviation of the transfer position in the position adjusting mechanism, the position deviation may not be corrected accurately, thus impeding an improvement of position adjusting accuracy. Recently, processes requiring a higher accuracy for transfer position adjustment are increasing. Thus, it is required to enhance the accuracy of the transfer position adjustment more than that of conventional level to be suitable for these processes.

The present invention has been conceived in view of the foregoing, and the object of the present invention is to provide a method for adjusting a transfer position of a transfer system capable of efficiency carrying out a transfer position adjustment of a higher accuracy regardless of an installation state of modules constituting the transfer system, thus capable of being adapted for use in a process requiring a higher level of accuracy.

### Means for Solving the Problems

In accordance with a first aspect of the present invention, there is provided a transfer position adjusting method, in a transfer system including: a position adjusting device for detecting a position deviation of a target object to be transferred; and a module capable of receiving the target object loaded thereinto, the transfer system being capable of transferring the target object to preset transfer positions of the position adjusting device and the module through a plurality of transfer paths, the method adjusting, when one of the plurality of transfer paths is set as a reference transfer path, a position transferred along the other transfer path to a position transferred along the reference transfer path in the module, the method including: detecting a position deviation of a position adjusting target object to be transferred, after returning it back from the module to the position adjusting device through the other transfer path, from a position where the position adjusting target object was placed before transferring it from the position adjusting device to the module through the reference transfer path; detecting a position deviation of the position adjusting target object after transferring it, which has been shifted from a transfer position in the module by a predetermined shift amount along a direction in which a correction of the position deviation can be made, up to the position adjusting device from the module through the other transfer path, and obtaining a coordinate system for correcting the position deviation by calculating a position deviation direction of a transfer position in the position adjusting device corresponding to a direction along which the correction of the transfer position deviation in the module is possible based on a multiplicity of position deviation detection results obtained by repeating the detection of the position deviation several times while varying the shift amount; and correcting the transfer position in the module by the other transfer path based on the coordinate system for correcting the position deviation so as to reduce the detected position deviation.

In accordance with the present invention, when the target object to be transferred is transferred between the position adjustment device and the module through the other transfer path, the coordinate system for correcting the position deviation is obtained by calculating a position deviation direction of a transfer position in the position adjusting device corresponding to a direction along which the correction of the transfer position deviation in the module is possible, whereby even in case that the installation position or angle of the module is different from original designs, the coordinate system for correcting the position deviation reflects the deviation of the installation position, or the like. Accordingly, the transfer position in the module by the other transfer path can be accurately corrected regardless of whether or not the installation position of the module is deviated and irrespective of a size or a direction of the deviation. As a result, a position transferred along the other transfer path an be adjusted to a position transferred along the reference transfer path in the module with a very high accuracy.

The transfer system includes a transfer device having a number of picks for holding the target object, and each of the plurality of transfer paths can be a transfer path along which the target object is transferred by a different pick of the transfer device. For this reason, even if the target object to be transferred is transferred to the module by using any one of a plurality of picks, the target object can be transferred to the same transfer position.

The module can be one of a processing module for performing a preset process on the loaded target object; a transit module for transiting the target object when the target object is transferred to the processing module; a transfer module having a transfer device accessible to the processing chamber; and an accommodation module for accommodating the target object.

In accordance with a second aspect of the present invention, there is provided a transfer position adjusting method, in a transfer system including: a position adjusting device for detecting a position deviation of a target object to be transferred; and a plurality of transit modules for transiting the target object when transferring the target object to a preset transfer position, the method adjusting, when one of the plurality of transit modules is set as a reference transit module, a position transferred along a transfer path passing through the other transit module to a position transferred along a transfer path passing through the reference transit module, the method including: detecting a position deviation of a position adjusting target object to be transferred, after returning it back from the preset transfer position into the position adjusting device through the transfer path passing through the other transit module, from a position where the position adjusting target object was placed before transferring it from the position adjusting device to the preset transfer position through the transfer path passing through the reference transit module; obtaining a coordinate system for correcting the position deviation by calculating a position deviation direction of a transfer position in the position adjusting device corresponding to a direction along which the correction of the position deviation of the transfer position in the other transit module can be made when the target object is transferred between the position adjusting device and the preset transfer position through the transfer path passing through the other transit module; and correcting the transfer position in the other transit module based on the coordinate system or correcting the position deviation so as to reduce the detected position deviation.

In accordance with the present invention, when the target object to be transferred is transferred between the position adjustment device and the preset transfer position through the transfer path passing through the other transit module, the coordinate system for correcting the position deviation is obtained by calculating a position deviation direction of a transfer position in the position adjusting device corresponding to a direction along which the correction of the transfer position deviation in the other transit module is possible, whereby even in case that the installation position or angle of the other transit module is different from original designs, the coordinate system for correcting the position deviation reflects the deviation of the installation position, or the like. Accordingly, the transfer position in the other transit module by the other transfer path can be accurately corrected regardless of whether or not the installation position of the other transit module is deviated and irrespective of a size or a direction of the deviation As a result, a position transferred along the transfer path passing through the other transit module can be adjusted to a position transferred along the transfer path passing through the reference transit module with a very high accuracy.

In accordance with a third aspect of the present invention, there is provided a transfer position adjusting method, in a transfer system including: a position adjusting device for detecting a position deviation of a target object to be transferred; at least one processing module for performing a predetermined process on the target object loaded thereinto; at least one transit module for transiting the target object when the target object is transferred to the processing module; a first transfer device, having at least one pick unit for holding the target object, accessible to the position adjusting device and the transit module; and a second transfer device, having a first and a second pick unit for holding the target object, accessible to the transit module and the processing module, when among a plurality of transfer paths for the target object available between the position adjusting device and the processing module, a transfer path passing through the pick unit of the first transfer device, the transit module and the first pick unit of the second transfer device is set as a reference transfer path and a transfer path passing through the pick unit of the first transfer device, the transit module and the second pick unit of the second transfer device is set as the other transfer path, the method adjusting a position transferred along the other transfer path to a position transferred along the reference transfer path in the processing module, the method including detecting a position deviation of a position adjusting target object to be transferred, after returning it back from the processing module into the position adjusting device through the other transfer path, from a position where the position adjusting target object was placed before transferring it from the position adjusting device to the processing module through the reference transfer path; transferring the position adjusting target object, which was transferred to the processing module from the position adjusting device through the reference transfer path, to the second pick unit of the second transfer device by shifting the position adjusting target object from the transfer position in the processing module by a predetermined shift amount along a direction in which a correction of the position deviation can be made; detecting a position deviation of the position adjusting target object after returning the position adjusting target object to the position adjusting device through the other transfer path; and obtaining a coordinate system for correcting the position deviation by calculating a position deviation direction of the transfer position in the position adjusting device corresponding to a direction along which the correction of the position deviation of the transfer position in the processing module can be made based on a multiplicity of position deviation detection results obtained by repeating the detection of the position deviation several times while varying the shift amount; and correcting the transfer position in the processing module by the other transfer path based on the coordinate system for correcting the position deviation so as to reduce the detected position deviation.

In accordance with the present invention, when the target object to be transferred is transferred between the position adjustment device and the processing module through the other transfer path, the coordinate system for correcting the position deviation is obtained by calculating a position deviation direction of a transfer position in the position adjusting device corresponding to a direction along which the correction of the transfer position deviation in the processing module is possible, whereby even in case that the installation position or angle of the processing module is different from original designs, the coordinate system for correcting the position deviation reflects the deviation of the installation position, or the like. Accordingly, the transfer position in the processing module by the other transfer path can be accurately corrected regardless of whether or not the installation position of the processing module is deviated and irrespective of a size or a direction of the deviation. As a result, a position transferred along the other transfer path can be adjusted to a position transferred along the reference transfer path in the processing module with a very high accuracy.

The direction along which the correction of a position deviation of the second pick unit of the second transfer device with respect to the processing module can be made can be a loading direction of the second pick unit of the second transfer device into the processing module or a direction perpendicular to the loading direction.

It is desirable that in case that the transfer system includes a plurality of processing modules, the process of detecting the position deviation of the position adjusting target object before and after the transfer thereof, the process of obtaining the coordinate system for the correction of the position deviation, and the process of correcting the transfer position in the processing module are performed for each of the plurality of processing modules. Therefore, a position transferred along the other transfer path can be adjusted to a position transferred along the reference transfer path with respect to all the processing modules with a very high accuracy.

In accordance with a fourth aspect of the present invention, there is provided A transfer position adjusting method, in a transfer system including: a position adjusting device for detecting a position deviation of a target object to be transferred; at least one processing module for performing a predetermined process on the target object loaded thereinto; a first and a second transit module for transiting the target object when the target object is transferred to the processing module; a first transfer device, having at least one pick unit for holding the target object, accessible to the position adjusting device and each of the transit modules; and a second transfer device, having at least one pick unit for holding the target object, accessible to each of the transit modules and the processing module, when among a plurality of transfer paths for the target object available between the position adjusting device and the pick unit of the second transfer device, a transfer path passing through the pick unit of the first transfer device and the first transit module is set as a reference transfer path and a transfer path passing through the pick unit of the first transfer device and the second transit module is set as the other transfer path, the method adjusting a position transferred along the other transfer path to a position transferred along the reference transfer path on the pick unit of the second transfer device, the method including: detecting a position deviation of a position adjusting target object to be transferred, after returning it back from the pick unit of the second transfer device into the position adjusting device through the other transfer path, from a position where the position adjusting target object was placed before transferring it from the position adjusting device to the second pick unit of the second transfer device through the reference transfer path; mounting the position adjusting target object, which was transferred up to the pick unit of the second transfer device from the position adjusting device through the reference transfer path, in the second transit module by shifting the position adjusting target object from the transfer position on the pick unit of the second transfer device by a predetermined shift amount along a direction in which a correction of the position deviation can be made; detecting a position deviation of the position adjusting target object after returning the position adjusting target object to the position adjusting device from the second transit module through the other transfer path; and obtaining a coordinate system for correcting the position deviation by calculating a position deviation direction of the transfer position in the position adjusting device corresponding to a direction along which the correction of the position deviation on the pick unit of the second transfer device can be made based on a multiplicity of position deviation detection results obtained by repeating the detection of the position deviation several times while varying the shift amount; and correcting the transfer position on the pick unit of the second transfer device by the other transfer path based on the coordinate system for correcting the position deviation so as to reduce the detected position deviation.

In accordance with the present invention, when the target object to be transferred is transferred between the position adjustment device and the pick unit of the second transfer device through the other transfer path, the coordinate system for correcting the position deviation is obtained by calculating a position deviation direction of a transfer position in the position adjusting device corresponding to a direction along which the correction of the transfer position deviation on the pick unit of the second transfer device is possible, whereby even in case that the installation position or angle of the second transit module is different from original designs, the coordinate system for correcting the position deviation reflects the deviation of the installation position, or the like. Accordingly, the transfer position in the second transit module by the other transfer path can be accurately corrected regardless of whether or not the installation position of the second transit module is deviated and irrespective of a size or a direction of the deviation. As a result, a transfer position on the pick unit of the second transfer device by the transfer path passing through the second transit module can be adjusted to a transfer position on the pick unit of the second transfer device by the transfer path passing through the first transit module with a very high accuracy.

The direction along which the correction of a position deviation of the pick unit of the second transfer device with respect to the second transit module can be a loading direction of the pick unit of the second transfer device into the second transit module or a direction perpendicular to the loading direction.

It is desirable that in case that the second transfer device includes a plurality of pick units, the process of detecting the position deviation of the position adjusting target object before and after the transfer thereof, the process of obtaining the coordinate system for correcting the position deviation, and the process of correcting the transfer position on the pick unit of the second transfer device are performed for each of the plurality of pick units of the second transfer device. In this way, a position transferred along the other transfer path can be adjusted to a position transferred along the reference transfer path with respect to all the picks of the second transfer device with a very high accuracy.

### EFFECT OF THE INVENTION

In accordance with the present invention, a transfer position adjustment having a higher accuracy can be carried out regardless of installation conditions of constituent modules of a transfer system.

### BRIEF DESCRIPTION OF THE DRAWINGS

FIG. 1 is a plane view illustrating a configuration of a substrate processing apparatus in accordance with an embodiment of the present invention;

FIG. 2 sets forth a block diagram showing a configuration of a control unit in accordance with the embodiment of the present invention;

FIG. 3 depicts a diagram showing a transfer path between an orienter and a second processing chamber in accordance with the embodiment of the present invention;

FIG. 4 presents a diagram showing an orienter coordinate system on which a center position of a dummy wafer in the orienter is plotted;

FIG. 5 provides a diagram of a transfer position coordinate system (Rθ coordinate system) of a pick B2 with respect to the second processing chamber, which is overlapped on the orienter coordinate system of FIG. 4;

FIG. 6 offers a diagram illustrating a relationship between a transfer position coordinate system in the second processing chamber and a coordinate system in the orienter with respect to the second processing chamber;

FIG. 7 is a diagram showing a correction direction and a correction amount of transfer position coordinates in case that the transfer position coordinate system (R axis and θ axis) in the second processing chamber does not coincide with the coordinate system (Ra axis and θa axis) in the orienter with respect to the second processing chamber;

FIG. 8 is a diagram showing a correction direction and a correction amount when correcting transfer position coordinates by using a coordinate system for correction of a position deviation;

FIG. 9 sets forth a flowchart showing a specific example of a transfer position adjusting process in accordance with the embodiment of the present invention;

FIG. 10 offers a flowchart showing a specific example of a transfer position adjusting process between a common transfer chamber and the orienter in FIG. 9;

FIG. 11 presents a flowchart showing a specific example of a first-step transfer position adjusting process of FIG. 10;

FIG. 12 provides a diagram showing a transfer path of a dummy wafer transferred by a transfer system during the second-step transfer position adjusting process of FIG. 10;

FIG. 13 is a flowchart showing a specific example of the second-step transfer position adjusting process of FIG. 10;

FIG. 14 offers a diagram showing a coordinate system for the correction of a position deviation, obtained in the second-step transfer position adjusting process of FIG. 13;

FIG. 15 sets forth a diagram showing a correction direction and a correction amount when correcting transfer position coordinates by using the coordinate system for the correction of the position deviation shown in FIG. 14;

FIG. 16 depicts a diagram illustrating a position deviation correction coordinate system acquired when performing the second-step transfer position adjusting process of FIG. 10 to the pick B2;

FIG. 17 is a flowchart showing a specific example of a transfer position adjusting process between a processing chamber and the orienter in FIG. 9;

FIG. 18 presents a flowchart showing a specific example of a first-step position adjusting process of FIG. 17;

FIG. 19 provides a diagram showing a transfer path of a dummy wafer transferred by a transfer system during the second-step transfer position adjusting process of FIG. 17;

FIG. 20 is a flowchart showing a specific example of the second-step transfer position adjusting process of FIG. 17;

FIG. 21 offers a diagram showing a coordinate system for correction of a position deviation, obtained in the second-step transfer position adjusting process of FIG. 20;

FIG. 22 sets forth a diagram showing a correction direction and a correction amount when correcting transfer position coordinates by using the coordinate system for the correction of the position deviation shown in FIG. 21.

### EXPLANATION OF CODES

100: Substrate processing apparatus

200: Processing unit

210: Common transfer chamber

212: Processing unit side transfer mechanism

220A˜220D: First to fourth processing chambers

222A˜222D: Mounting tables

230M: First load lock chamber

230N: Second load lock chamber

232M: Transfer table

932N: Transfer table

240A to 240D: Gate valves

300: Transfer unit

302A˜302C: Cassette vessels

304A˜304C: Inlet ports

306A˜306C: Loading openings

310: Inlet side transfer chamber

312: Transfer unit side transfer mechanism

314: Base

320: Orienter

322: Rotary mounting table

324: Optical sensor

400: Control unit

450: Input/output unit

470: Controllers

482: Transfer program

484: Process program

490: Setup information storage unit

492: Transfer setup information storage region

494: Process setup information storage region

A1, A2, B1, B2: Picks

W: Wafer

Wd: Dummy wafer

Xa, Xb: Transfer paths

X11˜X14: Transfer paths

X21˜X24: Transfer oaths

### BEST MODE FOR CARRYING OUT THE INVENTION

Hereinafter, desirable embodiments of the present invention will be described In detail with reference to the accompanying drawings. Through the whole document, parts having substantially same function and configuration will be assigned like reference numerals, and redundant description thereof will be omitted.

(Example of Transfer System)

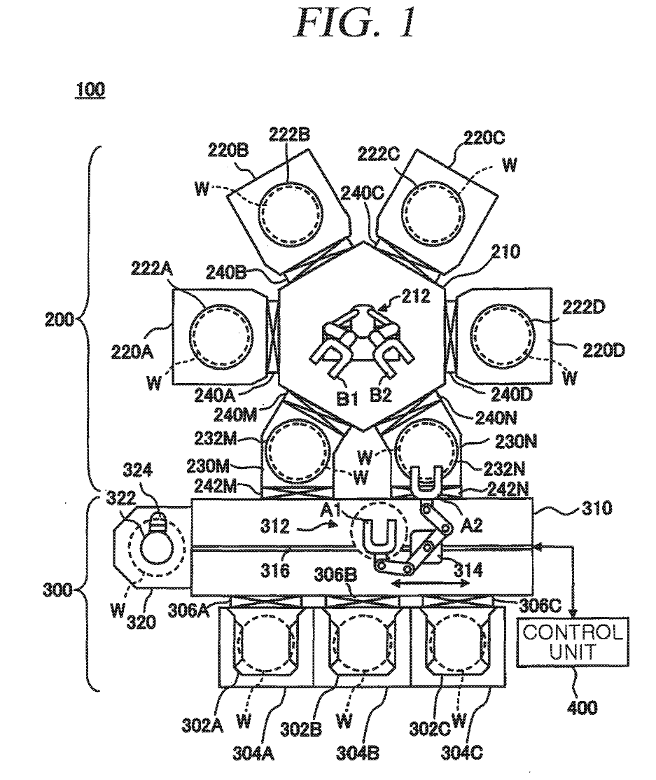

First, a transfer system in accordance with an embodiment of the present invention will be explained in conjunction with the accompanying drawings. Here, exemplified is a substrate processing apparatus capable of serving as a transfer system for transferring a substrate such as a wafer. FIG. 1 illustrates a schematic configuration of a substrate processing apparatus 100 in accordance with the embodiment of the present invention. The substrate processing apparatus 100 includes a processing unit 200 for performing various kinds of processes such as a film forming process, an etching process, and the like on a target substrate, e.g., a semiconductor wafer W; a transfer unit 300 for loading and unloading the wafer W to and from the processing unit 200; and a control unit 400 for controlling the entire operation of the substrate processing apparatus 100.

As shown in FIG. 1, the transfer unit 300 includes an inlet side transfer chamber 310 for loading and unloading the wafer W between substrate receptacles, e.g., cassette vessels 302 (302A to 302C) and the processing unit 200. The inlet side transfer chamber 310 is formed in a box shape having a substantially polygonal cross section (e.g., a rectangular cross section). A plurality of inlet ports 304 (304A to 304C) configured to mount thereon the cassette vessels 302A and 302C is arranged in juxtaposition at one side of the inlet side transfer chamber 310. Further, each cassette vessel installed at the inlet ports functions as an accommodation module for accommodating the wafer W therein.

Each cassette vessel 302 (302A to 302C) is capable of accommodating therein, e.g., a maximum of 25 sheets of wafers W while mounting them in multi-levels at a same pitch, and has a hermetically sealed interior structure filled with, e.g., a N₂ gas atmosphere. The respective cassette vessels 302A to 302C are connected with the inlet side transfer chamber 310 via loading openings 306A to 306C through which loading/unloading of the wafers W can be carried out. Further, the number of the inlet ports 304 and the cassette vessels 302 is not limited to the example illustrated in FIG. 1.

Disposed at an end portion of the inlet side transfer chamber 310, i.e., at a side constituting a short side of the substantially polygonal cross section thereof is an orienter (pre-alignment stage) 320 serving as a position adjusting mechanism. The orienter 320 has therein a rotary mounting table 322 and an optical sensor 324 for optically detecting a peripheral portion of the wafer W. The rotary mounting table 322 has a sensor (not shown) for detecting whether or not the wafer W is mounted thereon. In the orienter 320, an orientation flat or a notch previously formed in the wafer W, for example, is detected by the optical sensor 324, and the rotation angle of the wafer W is adjusted based on the detection result. Further, the amount and direction of a deviation between the center of the wafer W and the center of rotation of the rotary mounting table 322 is also detected by the optical sensor 324. This transfer position information of the wafer W is transmitted to the control unit 400.

Installed inside the inlet side transfer chamber 310 is a transfer unit side transfer device (first transfer device) 312 for transferring the wafer W along a lengthwise direction (a direction marked by an arrow in FIG. 1) thereof. A base 314, on which the transfer unit side transfer device 312 is fixed, is slidably supported on a guide rail 316 which is installed In a central portion of the inlet side transfer chamber 310 along the lengthwise direction thereof. Each of the base 314 and the guide rail 316 has a mover and a stator of a linear motor. A linear motor driving mechanism (not shown) for driving the linear motor is installed at an end portion of the guide rail 316. The linear motor driving mechanism is controlled based on a control signal from the control unit 400, whereby the transfer unit side transfer device 312 and the base 314 are made to move along the guide rail 316 in a direction marked by the arrow.

The transfer unit side transfer device 312 adopts a so-called double-arm structure having two arm units. Each arm unit has, for example, a multi-joint structure capable of being extended and retracted, moved up and down and revolved. Picks A1 and A2 for holding the wafer W are installed at leading ends of the arm units, respectively, so that the transfer unit side transfer device 312 can handle two sheets of wafers W at the same time. By using the transfer unit side transfer device 312 as described, the wafers W can be loaded and unloaded to be exchanged with respect to, e.g., the cassette vessels 302, the orienter 320 and a first and a second load lock chambers 230M and 230N which will be described later. Each of the picks A1 and A2 of the transfer unit side transfer device 312 has a sensor (not shown) for detecting whether or not the wafer W is held thereon. Further, the number of the arm units of the transfer unit side transfer device 312 is not limited to the aforementioned example, and it can be configured as, for example, a single-arm mechanism having only one arm.

Now, a configuration example of the processing unit 200 will be explained. Since the processing unit 200 is configured as, for example, a type of a cluster tool, as illustrated in FIG. 1 the processing unit 200 includes a common transfer chamber 210 having a polygonal cross section (e.g., a hexagonal cross section); a plurality of processing chambers 220 (a first to a fourth processing chamber 220A to 220D) and the first and second load lock chambers 230M and 230N arranged around and airtightly connected to the common transfer chamber. Each of the first to the fourth processing chambers 220A to 220D constitutes a processing module for performing a preset process on the wafer, and the first and second load lock chambers 230M and 230N constitute a first and a second transit module for transiting the wafer W during its transfer, respectively.

The first to the fourth processing chambers 220A to 220D are connected to the common transfer chamber 210 via gate valves 240A to 240D, respectively. Further, leading ends of the first and second load lock chambers 230M and 230N are connected with the common transfer chamber 210 via gate valves (vacuum side gate valves) 240M and 240N, respectively, while base ends of the first and second load lock chambers 230M and 230N are connected with the other side of the inlet side transfer chamber 310 via gate valves atmospheric side gate valves) 242M and 242N, respectively.

The processing chambers 220A to 220D have therein mounting tables (susceptors) 222A to 222D, respectively, and the wafer W mounted thereon is subjected to a preset process such as a film forming process (e.g., a plasma CVD process) or an etching process (e.g., a plasma etching process), or the like. Further, connected to each of the processing chambers 220A to 220D are a gas introduction system (not shown) for introducing preset gases such as a processing gas, a purge gas and the like to the inside thereof and a gas exhaust system (not shown) for evacuating them from the inside thereof. The number of the processing chambers 220 is not limited to the example shown in FIG. 1.

Each of the first and second load lock chambers 230M and 230N has a function of passing the wafer W to a next processing step after adjusting a pressure while accommodating the wafer W therein temporarily. Transfer tables 232M and 232N for mounting thereon the wafer W are installed inside the first and second load lock chambers 230M and 230N, respectively.

Installed inside the common transfer chamber 210 is a processing unit side transfer device (second transfer device) 212 adopting a so-called double-arm structure with two arm units. Each arm unit of the processing unit side transfer device 212 has a multi-joint structure which is extensible/retractable, movable up and down and also revolvable. Picks B1 and B2 for holding the wafer W are installed at leading ends of the arm units, respectively. Thus, the processing unit side transfer device 212 is capable of handling two sheets of wafers W at the same time and the wafers W can be transferred between each of the load lock chambers 230M and 230N and each of the processing chambers 220A to 220D. Each of the picks B1 and B2 of the processing nit side transfer device 212 has a sensor (not shown) for detecting whether or not the wafer W is held thereon. Further, the number of the arm units of the processing unit side transfer device 212 is not limited to the aforementioned example, and it can be configured as, for example, a single-arm mechanism having only one arm.

The control unit 400 controls the entire operation of the substrate processing apparatus 100 including the transfer unit side transfer device 312, the processing unit side transfer device 212, each gate valve, the rotary mounting table 322 of the orienter 320, and so forth. Moreover, the control unit 400 has a function of receiving and storing data indicating a position deviation amount or a position deviation direction of the wafer W detected by the optical sensor 324 in the orienter 320, and carrying out an operation of this data according to a preset sequence.

(Configuration Example of Processing Unit)

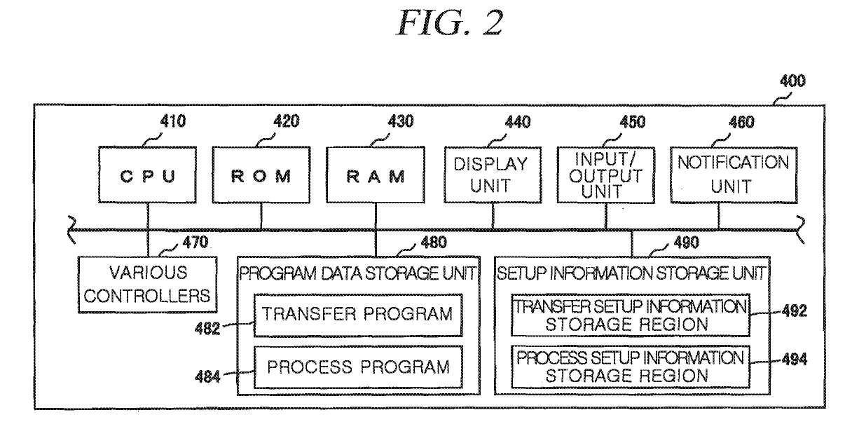

Subsequently, a specific example of the control unit 400 will be explained with reference to the accompanying drawings. As shown in FIG. 2, the control unit 400 includes a CPU (Central Processing Unit) 410 constituting a control unit main body; a ROM (Read Only Memory) 420 for storing therein, e.g., data with which the CPU 410 controls each component; a RAM (Random Access Memory) 430 having, e.g., a memory region used for various types of data processing performed by the CPU 410; a display unit 440 made up of a liquid crystal display or the like for displaying a manipulation screen, a selection screen, or the like; an input/output unit 450 by which an operator can perform an input/output of various data; a notification unit 460 made up of, e.g., an alarm such as a buzzer, or the like; various kinds of controllers 470 for controlling each component of the substrate processing apparatus 100; a program data storage unit 480 for storing therein various kinds of program data applied to the substrate processing apparatus 100; and a setup information storage unit 490 for storing therein various kinds of setup information used when performing a program processing based on the program data. Each of the program data storage unit 480 and the setup information storage unit 490 is made up of a storage medium such as a flash memory, a hard disk, a CD-ROM, or the like, and the data are read by the CPU 410 when necessary.

The program data storage unit 480 stores therein a transfer program 482 for storing e.g., a program for controlling the operations of the transfer unit side transfer device 312 and the processing unit side transfer device 212; and a process program 484 for storing therein programs executed when performing the process on the wafer W in each of the processing chambers 220A to 220D.

Further, the setup information storage unit 490 has, for example, a transfer setup information storage region 492 for storing therein transfer position coordinates of places to which the transfer unit side transfer device 312 and the processing unit side transfer device 212 have access to transfer the wafer W; and a process setup information storage region 494 for storing therein recipe data such as a pressure inside the processing chamber, a gas flow rate, a high frequency power, and the like during the process. The transfer setup information storage region 492 can store therein transfer position coordinates of each place individually. When, for example, correcting the transfer position coordinates stored in the transfer setup information storage region 492, the transfer position coordinates are replaced with the corrected transfer position coordinates, and the corrected transfer position coordinates are stored (overwritten) therein and finally decided. Further, when correcting the once decided transfer position coordinates again, they are replaced with the corrected transfer position coordinates and stored (overwritten) therein so that the transfer position coordinates are finally decided.

The CPU 410, the ROM 420, the RAM 430, the display unit 440, the input/output unit 450, the notification unit 460, various controllers 470, the program data storage unit 480 and the setup information storage unit 490 are electrically connected with each other by a bus line such as a control bus, a system bus, a data bus, or the like.

(Schematic Description of a Transfer Position Adjusting Process by the Transfer System)

Subsequently, a transfer position adjusting process (teaching operation) performed by using the above-described substrate processing apparatus (transfer system) 100 will be explained with reference to the accompanying drawings in this transfer position adjusting process, a dummy wafer Wd for transfer position adjustment is used instead of the product wafer W on which the preset processes are performed in each of the processing chambers 220A to 220D. The dummy wafer Wd is made of a transparent plate, and its diameter and thickness are substantially identical with those of the product wafer W. Further, a mark corresponding to the outline of the picks A1, A2, B1 and B2 is printed on the surface of the dummy wafer Wd. By allowing the mark to coincide with the outline of each pick, the dummy wafer Wd can be held at a proper position on each pick.

Further, in the transfer position adjusting process, a position alignment with respect to each of the mounting tables 222A to 222D of each of the processing chambers 220A to 220D (second transfer position adjusting process) is performed after completing a position adjustment with respect to every transfer path available between the common transfer chamber 213 and the orienter 320 (first transfer position adjusting process). Accordingly, the wafer can be transferred to the same position on each of the mounting tables 222A to 222D whichever transfer path it takes.

Furthermore, when each of the transfer devices 212 and 312 accesses a same position with different picks, these transfer paths are regarded as different paths. That is, since either one of the picks A1 and A2 of the transfer unit side transfer device 312 is selectively used to transfer the wafer W to either one of the load lock chambers 230M and 230N from the orienter 320 in the above-stated substrate processing apparatus 100, there exist two transfer paths. Further, since either one of the picks B1 and B2 of the processing unit side transfer device 212 is selectively used to transfer the wafer W to each of the processing chambers 220A to 220D and the wafer W is transferred via either one of the first and the second load lock chambers 230M and 230N at each time, there exist four transfer paths. Accordingly, to finally transfer the wafer W to each of the processing chambers 220A to 220D, a maximum of eight transfer paths are available depending on the combination of the load lock chambers 230M and 230N and the picks A1, A2, B1 and B2 employed for that transfer.

As for the two transfer paths via the pick A1 or A2 of the transfer unit side transfer device 312 among the plural transfer paths, since the picks A1 and A2 have direct accesses to the orienter 320 and the first and second load lock chambers 230M and 230N, transfer position coordinates is determined by having direct access with respect to each of them. In contrast, as for the four transfer paths via the pick B1 or B2 of the processing unit side transfer device 212, the picks B1 and B2 cannot access the orienter 320 directly. Accordingly, after determining two transfer paths via the picks A1 and A2 of the transfer unit side transfer device 312, transfer position coordinates are determined by indirectly carrying out the transfer position adjustment by the orienter 320 while using either one of these two transfer paths.

Here, explained is the transfer position adjusting process for the four transfer paths via the pick B1 or B2 or the processing unit side transfer device 2212 and the load lock chamber 230M or 230N. A transfer position for one of these four transfer paths is determined, and this transfer path is set as a reference transfer path. Then, transfer positions by the other transfer paths are corrected to be adjusted to the transfer position to which the wafer W is transferred through the reference transfer path.

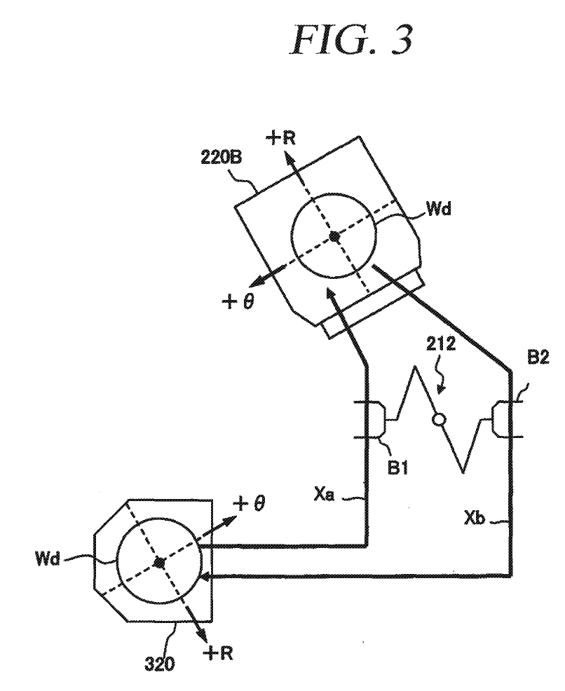

With reference to the accompanying drawing, there will be explained two example cases in which a transfer path Xa via the pick B1 of the processing unit side transfer device 212 and a transfer path Xb via its pick B2 are taken respectively when transferring the wafer W to a preset transfer position (e.g., onto the mounting table 222B) inside the second processing chamber 220B. FIG. 3 is a diagram showing a transfer path between the orienter 320 and the second processing chamber 220B. In FIG. 3, illustration of other places other than the orienter 320 and the second processing chamber 220B is omitted for the convenience of explanation.

First, a transfer position of the wafer W transferred into the second processing chamber 220B through the transfer path Xa via the pick B1 of the processing unit side transfer device 212 is decided through, e.g., the above-stated manual manipulation using the dummy wafer Wd, and this transfer path Xa is set as the reference transfer path. Subsequently, the dummy wafer Wd properly positioned inside the orienter 320 is temporarily transferred to the preset transfer position inside the second processing chamber 220B via the transfer path Xa which is the reference transfer path. Subsequently, the dummy wafer Wd is returned back into the orienter 320 via the transfer path Xb which is the other transfer path.

Then, a position deviation of the dummy wafer Wd before and after the transfer is detected in the orienter 320, and the transfer position transferred along the transfer path Xb, which is the other transfer path, is corrected so as to reduce the detected position deviation. To elaborate, the transfer position of the pick B2 of the processing unit side transfer device 212 with respect to the processing chamber 220B is corrected in the orienter 320 such that the center of the dummy wafer Wd is identical before and after the transfer.

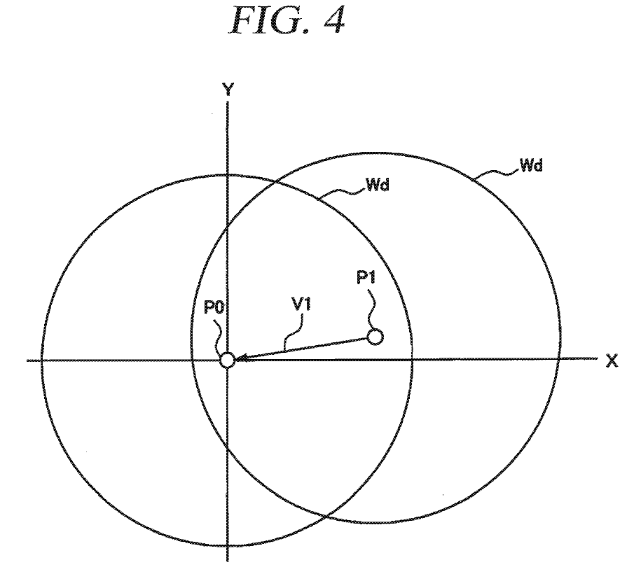

An example method for correcting the transfer position transferred along the other transfer path will be explained in detail. FIG. 4 illustrates a case where centers P0 and P1 of the dummy wafer Wd before and after the aforementioned transfer is denoted by P0 and P1 on a coordinate system (XY coordinate system) of the orienter 320. Further, since a position deviation from the center of the dummy wafer Wd before and after the transfer is detected in the orienter 320 as, e.g., a position deviation amount (eccentric amount) V and a position deviation direction (eccentric direction) α, the product (V×cos α) of the position deviation amount V and a cosine function of the positional deviation direction α is obtained on an X axis of the coordinate system for the orienter 320, while the product (V×sin α) of the position deviation amount V and a sine function of the position deviation direction α is taken on an Y axis thereof. In the present example, since P0 and P1 of the dummy wafer Wd is deviated by V1 the transfer position of the pick B2 with respect to the second processing chamber 220B (mounting table 222B) is corrected by the control unit 400 so as to reduce the position deviation V1.

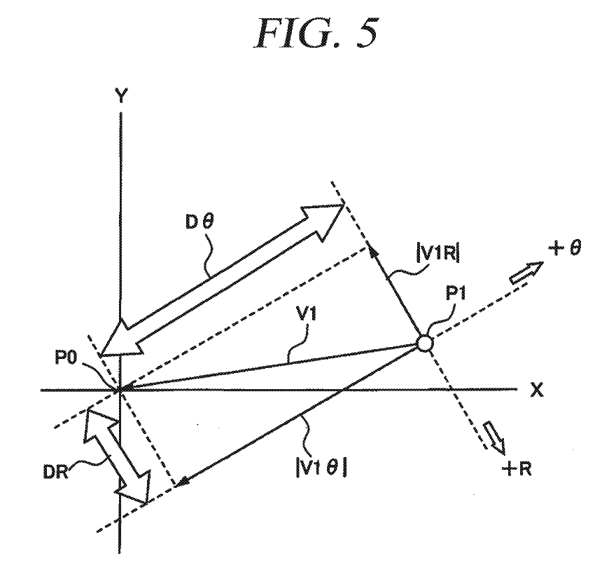

Here, if a transfer position coordinate system (Rθ coordinate system) of the pick B2 for the second processing chamber 220B (mounting table 222B) is overlapped on the coordinate system (XY coordinate system) of the orienter 320, a diagram as shown in FIG. 5 is obtained. The transfer position coordinate system shown by dotted lines in FIG. 5 is represented by the origin which is the center position of the dummy wafer Wd; a θ axis which is a straight-line approximation of a rotation angle of the arm of the pick B2; and an R axis indicating extending/retracting directions. Further, in the present embodiment, a left rotational direction of the arm of the pick B1 or B2 is defined as a plus direction of the θ axis, and an extending direction of the arm is defined as a plus direction of the R axis.

As illustrated in FIG. 5, a vector V1 indicating the position deviation of the dummy wafer Wd in the orienter 320 can be decomposed to a R-axis directional vector V1R (size |V1R|) and a θ-axis directional vector V1θ (size |V1θ|) on the transfer position coordinate system. Accordingly, If the transfer position of the pick B2 with respect to the second processing chamber 220B is corrected by a correction amount |V1R| along a minus direction of the R axis and by a correction amount |V1θ| along a minus direction of the θ axis, P1 is rendered coincident with P0. In such case, the R-axis correction amount |V1R| is calculated from, e.g., a distance (DR) between the straight-line θ axis and P0, while the Y-axis correction amount |V1θ| is calculated from, e.g., a distance Dθ between the straight-line R axis and P0.

In this way, the transfer position transferred along the transfer path Xa used as the reference transfer path and the transfer position transferred along the transfer path Xb set as the other transfer path can become coincident with each other. Moreover, just by deciding the transfer position transferred along only one transfer path through the manual manipulation, position adjustment for the other transfer path can be carried out automatically. Thus, the number of transfer positions required to be adjusted through the manual manipulation can be reduced.

Meanwhile, the position deviation has been conventionally corrected on the assumption that the deviation of the transfer position in a module such as the processing chamber 220 or the load lock chamber 230 (e.g., a position deviation amount or direction of the center position of the wafer W) is always coincident with the deviation of the transfer position in the orienter 320 serving as the position ad using mechanism. That is, the vector V1 indicating the position deviation on the coordinate system (XY coordinate system) of the orienter 320 has been assumed to be coincident with the vector V1 indicating the position deviation on the transfer position coordinate system (Rθ coordinate system), and correction of the transfer position coordinates in each module has been carried out based on this assumption.

Actually, however, it was proved from experiments that the deviation of the transfer position in the processing chamber 220 may not be coincident with the deviation of the transfer position in the orienter 320 due to, e.g., an installation error of the processing chamber 220, the load lock chamber 230 and the orienter 320, and the like.

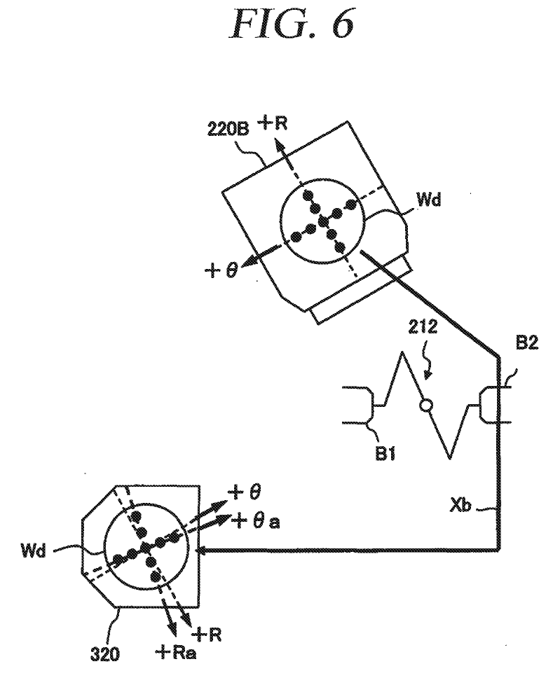

For example, as illustrated in FIG. 6, the center position of the dummy wafer Wd in the second processing chamber 220B was shifted by, e.g., about 0.15 mm along the R-axis direction and the θ-axis direction; the dummy wafer Wd is transferred into the orienter 320 through the transfer path Xb by the pick B2; and then the position deviation of the dummy wafer Wd was detected and plotted on the coordinate system of the orienter 320. As a result, the actual position deviations along the R-axis direction and the θ-axis direction on the coordinate system of the orienter 320 did not coincide with the position deviations along the R-axis direction and the θ-axis direction on the transfer position coordinate system (Rθ coordinate system) for the second processing chamber 220B.

As described, if the installation angle or position of the processing chamber 220, the orienter 320, or the like is deviated from a designed installation angle or position, a deviation direction of the transfer position of the dummy wafer Wb in the processing chamber 220 may not be coincident with a deviation direction of the transfer position of the dummy wafer Wb when it is transferred into the orienter 320 from the processing chamber 220.

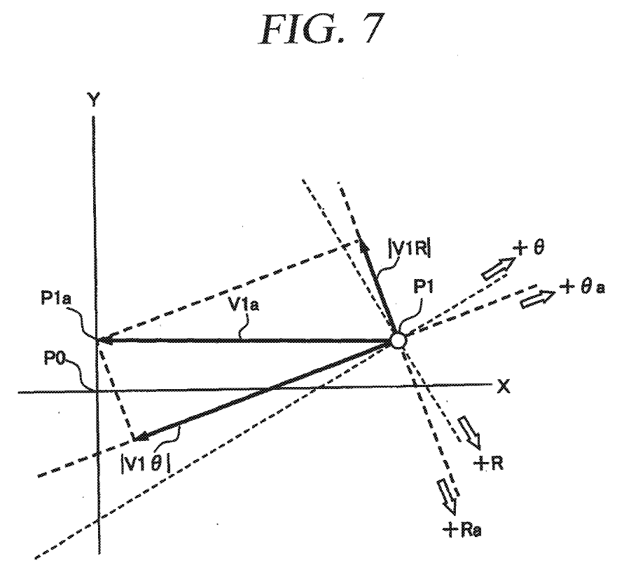

For instance, as shown in FIG. 7, in case that the transfer position coordinate system (R axis, θ axis) of the second processing chamber 220B is not coincident with an actual coordinate system (Ra axis, θa axis) in the orienter 320 with respect to the second transfer chamber 220B, a correction may be actually made by as much as |V1R| (vector V1Ra) along a minus direction of the Ra axis and |V1θ| (vector V1θa) along a minus direction of the θa axis, respectively, even if the correction is made by as much as the R-axis correction amount |V1R| and the θ-axis correction amount |V1θ|, which have been calculated from the coordinate system of FIG. 5, along the minus directions of the R axis and the θ axis, respectively.

Thus, as for the position of the dummy wafer Wd which has been transferred to the second processing chamber 220B from the orienter 320 through the transfer path Xa via the pick B1 and then returned to the orienter 320 from the second processing chamber 220B through the transfer path Xb via the pick B2, the amount of position deviation is reduced in comparison with a case where the correction is not made because its position is corrected from P1 to P1a. However, a position deviation as much as a distance between P0 and P1a still remains.

As described, if the correction of the transfer position coordinates is carried out based on the premise that the deviation of the transfer position in the processing chamber 220 was coincident with the deviation of the transfer position in the orienter 320 when the dummy wafer Wd was transferred back into the orienter 320 from the processing chamber 220, there arose occasions where a transfer position deviation remains in the order of about 1/10 millimeter depending on an installation accuracy of the processing chamber 220 or the like. That is, the position deviation may not be corrected accurately under the above premise, and there is a limitation in improving the accuracy of position adjustment.

Therefore, in the present embodiment, the correction of the position deviation of the transfer position is carried out based on a position deviation correction coordinate system, which is obtained by calculating directions (e.g., Ra axis and θa axis shown in FIGS. 6 and 7) along which the position deviation in the orienter 320 can be corrected and which correspond to position deviation correction directions (e.g., R axis and θ axis shown in FIGS. 6 and 7) of the transfer position coordinates for the processing chamber 220.

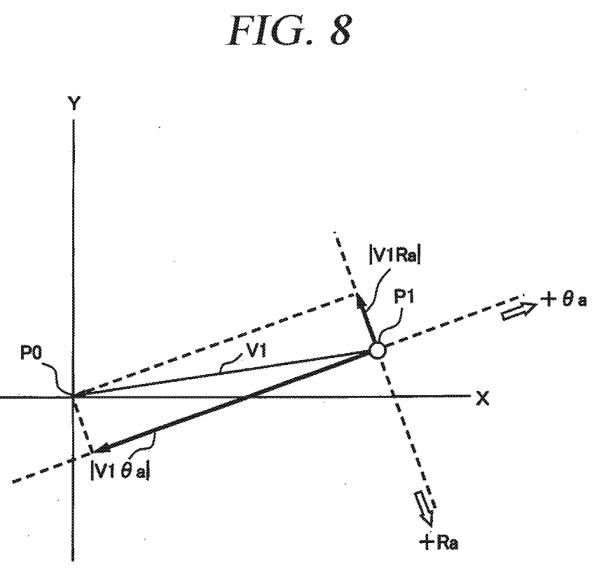

For instance, in the example shown in FIG. 7 described above, the coordinate system consisting of the Ra axis and the θa axis is set as the position deviation correction coordinate system, and a position deviation amount with respect to these Ra axis and θa axis is calculated. That is, as shown in FIG. 8, the vector indicating the position deviation of the dummy wafer Wd in the orienter 320 can be decomposed into the Ra-axis directional vector V1Ra (size |V1Ra|) and the θa-axis directional vector V1θa (size |V1θa|) on the position deviation correction coordinate system.

Accordingly, the correction amount of the transfer position coordinates of the pick B2 for the second processing chamber 220B corresponding to this position deviation correction coordinate system becomes a R-axis correction amount |V1Ra| alone a minus direction of the R axis and a θ-axis correction amount |V1θa| along a minus direction of the θ axis. Further, the R-axis correction amount |V1Ra| is calculated from, e.g., the distance between the straight-line θa axis and P0 and the θ-axis correction amount |V1θa| is calculated from, e.g., a distance between the straight-line Ra axis and P0.

By carrying out the correction as described above, the transfer position P1 through the other transfer path can be corrected so as to be coincident with the transfer position P0 through the reference transfer path with a high accuracy even in case that the installation position or angle of the processing chamber 220 is different from original designs. For example, a high position adjusting accuracy in the order of, e.g., about 1/100 millimeter can be obtained.

Here, an example method for acquiring the aforementioned position deviation correction coordinate system (Rθ coordinate system) will be explained in conjunction with FIG. 6. In FIG. 6, plots (black dots) overlapped on the second processing chamber 220B represent an access position of the pick B2 when the dummy wafer Wd is unloaded from the second processing chamber 220B by the pick B2. AS illustrated in FIG. 6, in the present embodiment, the dummy wafer Wd is unloaded by intentionally shifting the access position of the pick B2 along the R-axis direction and the θ-axis direction of the transfer position coordinate system for the second processing chamber 220B several times.

Then, by using plots (black dots) detected in the orienter 320 when the dummy wafer Wd unloaded from the processing chamber 220B by the pick B2 is returned back into the orienter 320 along the other transfer path Xb, the position deviation correction directions (Ra axis and θa axis) in the orienter 320 corresponding to the position deviation correction directions (R axis and θ axis) of the transfer position coordinates for the processing chamber 220 can be obtained. That is, the plots (black dots) overlapped on the orienter 320 in FIG. 6 represent the center position of the dummy wafer Wd detected in the orienter 320. If two approximate straight-lines are calculated based on the distribution of these plots (block dots), these two straight-lines become the Ra axis and the θa axis in the orienter 320 corresponding to the R axis and the θ axis of the transfer position coordinate system for the second processing chamber 220B.

In the present embodiment as described above, the dummy wafer Wd unloaded from the second processing chamber 220B by the pick B2 whose access position has been intentionally shifted is transferred into the orienter 320, and the position deviation correction direction in the orienter 320 with respect to the second processing chamber 220B is then determined by detecting the position deviation of the dummy wafer Wd in the orienter 320. Then, based on the determined result, the position deviation correction coordinate system is obtained.

Further, it may be possible to shift the position of the dummy wafer Wd in the second processing chamber 220B instead of shifting the access position of the pick B2 in the second processing chamber 220B. In such case, the plots (block dots) overlapped on the second processing chamber 220B in FIG. 6 indicate the center position of the dummy wafer Wd. The position deviation correction coordinate system can be obtained by either method.

(Specific Example of the Transfer Position Adjusting Process of the Transfer System)

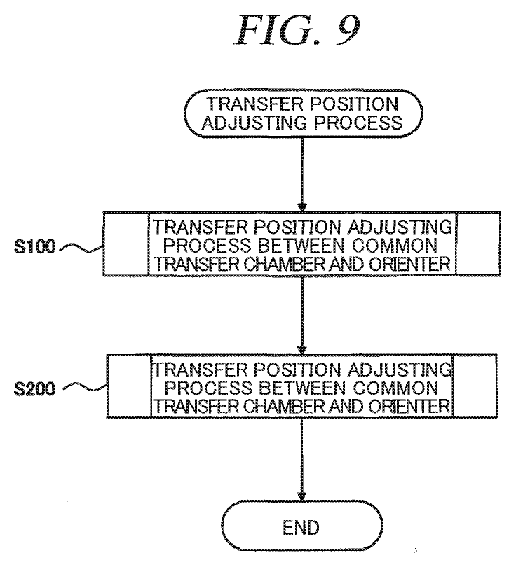

Now, a specific example of the transfer position adjusting process of the transfer system in accordance with the present embodiment of the present invention will be described with reference to the accompanying drawings. FIG. 9 is a flowchart showing a specific example of the transfer position adjusting process. In the present embodiment, position adjustment is carried out in sequence starting from a place closer to the orienter 320 in principle by considering efficiency or accuracy of the position adjusting operation. To be specific, after performing position adjustment with respect to all the transfer paths taken between the common transfer chamber 210 and the orienter 320 in step S100, position adjustment with respect to each of the mounting tables 222A to 222D in each of the processing chambers 220A to 220D is performed in step S200

In each of steps S100 and S200 described in FIG. 9, in addition to a first-step transfer position adjusting process for performing a correction of position adjustment with a certain level of accuracy (e.g., an accuracy allowing a transfer position error to be in the order of about 1/10 millimeter), there is performed a second-step transfer position adjusting process for performing a correction of position adjustment with a higher accuracy (e.g, an accuracy allowing a transfer position error to be in the order of about 1/100 millimeter,) By performing such two-step position adjustment, the wafer can be transferred to the same transfer position on each of the mounting tables 222A to 222D with a higher accuracy whichever transfer path it takes. Thus, the present invention can be applied to the processing chamber 220 which performs a process requiring a transfer position adjustment with a higher level of accuracy.

(Transfer Position Adjusting Process Between the Common Transfer Chamber and the Orienter)

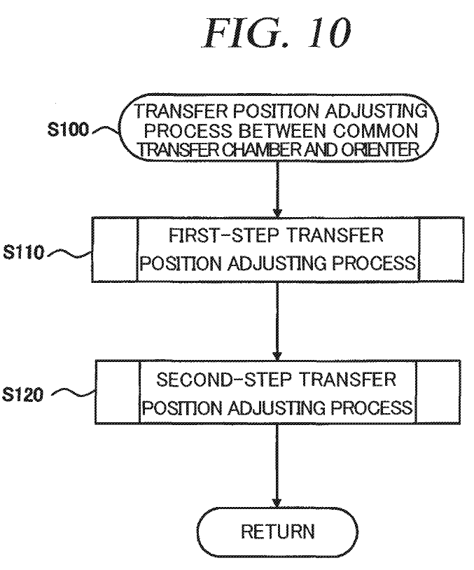

In the transfer position adjusting process (step S100) between the common transfer chamber 210 and the orienter 320 described in FIG. 9, a second-step transfer position adjusting process (step S120) is performed in addition to a first-step transfer position adjusting process (step S110) as shown in FIG. 10.

Further, prior to performing the first-step transfer position adjusting process in step S110, it is desirable to perform a so-called rough teaching operation for temporarily determining transfer position coordinates for every place (point) inside the substrate processing apparatus 100, to which each pick has access, by gradually moving the respective picks A1, A2, B1 and B2 while appropriately combining automatic and manual movements thereof.

Since the rough teaching is performed for the purpose of preventing the dummy wafer Wd held on the pick from contacting any component inside the substrate processing apparatus 100, the transfer position coordinates are temporarily determined with a Low level of accuracy of, e.g., about ±2 mm. The temporary transfer position coordinates are stored in the preset transfer setup information storage region 492 inside the setup information storage unit 490 of the control unit 400. Moreover, in case that an assembly error of the substrate processing apparatus 100, or the like is small, transfer position coordinates can be calculated from design dimensions of the substrate processing apparatus 100 and set as the temporary transfer position coordinates.

(First-Step Transfer Position Adjusting Process)

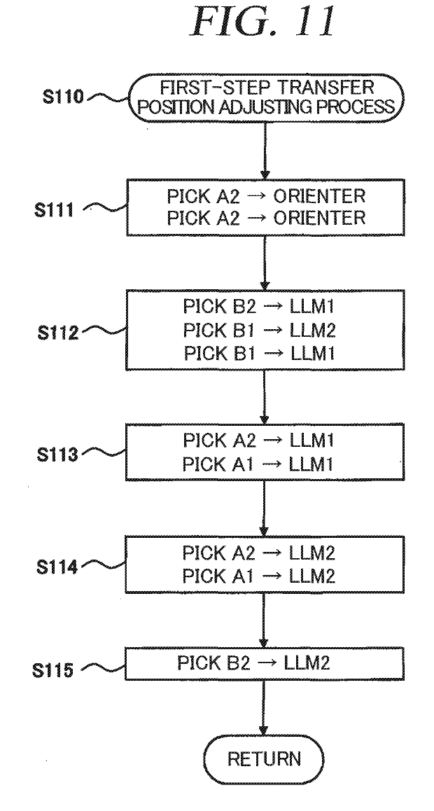

The first-step transfer position adjusting process (step S110) is performed based on a flowchart shown in FIG. 11, and is performed for the transfer position adjustment between the orienter 320 and the common transfer chamber 210 (e.g., each pick B1 or B2 of the processing unit side transfer device 212). In FIG. 11, the first load lock chamber 230M is simply referred to as a “LLM1”, while the second load lock chamber 230N is simply referred to as a “LLM2”.

First, in step S111 of the first-step transfer position adjusting process, the dummy wafer Wd is maintained on the pick A2 while appropriately aligned thereon, and it is automatically transferred to the orienter and moved onto the rotary mounting table 322 to be mounted thereon. Then, a position deviation amount (eccentric amount) V and a position deviation direction (eccentric direction) α of the dummy wafer Wd are detected by the optical sensor 324 while rotating the rotary mounting table 322. Transfer position information data indicating the position deviation amount V and the position deviation direction α detected at this time are transmitted to the control unit 400. Based on the transfer position information data, the control unit 400 corrects the transfer position coordinates of the pick A2 for the orienter 320 (rotary mounting table 322), which have been temporarily determined through the above-stated rough teaching operation, so as to reduce the position deviation of the dummy wafer Wd with respect to the rotary mounting table 322, and then finally decides the corrected transfer position coordinates by storing them.

Likewise, as for the pick A1, transfer position coordinates with respect to the orienter 320 (rotary mounting table 322) which are temporarily determined through the above-described rough teaching process are corrected, and the corrected transfer position coordinates are stored and finally decided. As described, by correcting the transfer position coordinates, the transfer position adjustments of the picks A2 and A1 with respect to the orienter 320 are completed. Thereafter, if the wafer W is automatically transferred to the orienter 320 by the pick A1 or A2, the wafer W is moved to and mounted on the rotary mounting table 322 so that its center substantially coincides with the center of the rotary mounting table 322.

In next step S112, position adjustment of the pick B2 with respect to the first load lock chamber 230M, position adjustment of the pick B1 with respect to the second load lock chanter 230N and position adjustment of the pick B1 with respect to the first load lock chamber 230M are performed through the manual manipulation.

To elaborate, by maintaining the dummy wafer Wd on the pick B2 while appropriately aligning it thereon, the dummy wafer Wd is manually transferred into the first load lock chamber 230M and moved onto the transfer table 232M to be finally mounted thereon. At this time, the access position of the pick B2 is adjusted such that the center of the dummy wafer Wd coincides with the center of the transfer table 232M. The control unit 400 changes the transfer position coordinates of the pick B2 with respect to the first load lock chamber 230M (transfer table 232M), which are temporarily determined through the above-stated rough teaching operation, into the access position coordinates of the pick B2 at this time, and finally decides the changed transfer position coordinates by storing them

Likewise, by maintaining the dummy wafer Wd on the pick B1 while appropriately aligning it thereon, the dummy wafer Wd is manually transferred into the second load lock chamber 230N and moved onto the transfer table 232N to be finally mounted thereon. At this time, the access position of the pick B1 is adjusted such that the center of the dummy wafer Wd coincides with the center of the transfer table 232N. The control unit 400 changes the transfer position coordinates of the pick B1 with respect to the second load lock chamber 230N (transfer table 232N), which are temporarily determined through the above-stated rough teaching operation, into the access position coordinates of the pick B1 at this time, and finally decides the changed transfer position coordinates by storing them.

Further, by maintaining the dummy wafer Wd on the pick B1 while appropriately aligning it thereon, the dummy wafer Wd is manually transferred into the first load lock chamber 230M and moved onto the transfer table 232M to be finally mounted thereon. At this time, the access position of the pick B1 is adjusted such that the center of the dummy wafer Wd coincides with the center of the transfer table 232M. The control unit 400 changes the transfer position coordinates of the pick B1 with respect to the first load lock chamber 230M (transfer table 232M) which are temporarily determined through the above-stated rough teaching operation, into the access position coordinates of the pick B1 at this time, and finally decides the changed transfer position coordinates by storing them.

Subsequently, in step S113, the dummy wafer Wd on the transfer table 232M of the first load lock chamber 230M is transferred by the pick A2 into the orienter 320 and is moved onto the rotary mounting table 322 to be mounted thereon. Then, a position deviation amount V and a position deviation direction α of the dummy wafer Wd are detected by the optical sensor 324 while rotating the rotary mounting table 322. Transfer position information data indicating the position deviation amount V and the position deviation direction α detected at this time are transmitted to the control unit 400. Based on the transfer position information data, the control unit 400 corrects the transfer position coordinates of the pick A2 with respect to the first load lock chamber 230M (transfer table 232M), which have been temporarily determined through the above-stated rough teaching operation, so as to reduce the position deviation of the dummy wafer Wd with respect to the rotary mounting table 322, and then finally decides the corrected transfer position coordinates by storing them.

Subsequently, the dummy wafer Wd mounted on the rotary mounting table 322 of the orienter 320 is mounted on the transfer table 232M of the first load lock chamber 230M by the pick A2. At this time, since the transfer position coordinates of the pick A2 with respect to the first load lock chamber 230M is already corrected, the center of the dummy wafer Wd is rendered substantially coincident with the center of the transfer table 232M.

Thereafter, the dummy wafer Wd on the transfer table 232M of the first load lock chamber 230M is transferred by the pick A1 into the orienter 320 and is moved onto the rotary mounting table 322 to be mounted thereon. Then, a position deviation amount V and a position deviation direction α of the dummy wafer Wd are detected by the optical sensor 324 while rotating the rotary mounting table 322. Transfer position information data indicating the position deviation amount V and the position deviation direction α detected at this time are transmitted to the control unit 400. Based on the transfer position information data, the control unit 400 corrects the transfer position coordinates of the pick A1 with respect to the first load lock chamber 230M (transfer table 232M), which have been temporarily determined through the above-stated rough teaching operation, so as to reduce the position deviation of the dummy wafer Wd with respect to the rotary mounting table 322, and then finally decides the corrected transfer position coordinates by storing them.

As described, in step S113, the transfer position adjustment of the pick A2 with respect to the first load lock chamber 230M (transfer table 232M) and the transfer position adjustment of the pick A1 with respect to the first load lock chamber 230M (transfer table 232M) are completed Thus, if the wafer W is automatically transferred into the first load lock chamber 230M by the pick A1 or A2 afterwards, the wafer W can be moved and mounted such that its center is aligned substantially coincident with the center of the transfer table 232M.

Further, in step S114, the dummy wafer Wd on the rotary mounting table 322 of the orienter 320 is moved by the pick A2 or A1 (here, the pick A2) onto the transfer table 232M of the first load lock chamber 230M and mounted thereon. Then, the dummy wafer Wd on the transfer table 232M of the first load lock chamber 230M is moved by the pick B1 onto the transfer table 232N of the second load lock chamber 230N and mounted thereon.

Thereafter, the dummy wafer Wd on the transfer table 232N of the second load lock chamber 230N is transferred by the pick A2 into the orienter 320 and is moved onto the rotary mounting table 322 to be mounted thereon. Then, a position deviation amount V and a position deviation direction α of the dummy wafer Wd are detected by the optical sensor 324 while rotating the rotary mounting table 322. Transfer position information data indicating the position deviation amount V and the position deviation direction α detected at this time are transmitted to the control unit 400. Based on the transfer position information data, the control unit 400 corrects the transfer position coordinates of the pick A2 with respect to the second load lock chamber 230N (transfer table 232N), which have been temporarily determined through the above-stated rough teaching operation and stored in the transfer setup information storage region 492 of the setup information storage unit 490, so as to reduce the position deviation of the dummy wafer Wd with respect to the rotary mounting table 322, and then finally decides the corrected transfer position coordinates by storing them.

Subsequently, the dummy wafer Wd on the rotary mounting table 322 of the orienter 320 is moved by the pick A2 onto the transfer table 232N of the second load lock chamber 230N to be mounted thereon. Thereafter, the dummy wafer Wd on the transfer table 232N of the second load lock chamber 230N is transferred by the pick A1 into the orienter 320 and mounted on the rotary mounting table 322. Then, a position deviation amount V and a position deviation direction α of the dummy wafer Wd are detected by the optical sensor 324 while rotating the rotary mounting table 322. Transfer position information data indicating the position deviation amount V and the position deviation direction α detected at this time are transmitted to the control unit 400. Based on the transfer position information data, the control unit 400 corrects the transfer position coordinates of the pick A1 with respect to the second load lock chamber 230N (transfer table 232M), which have been temporarily determined through the above-stated rough teaching operation and stored in the transfer setup information storage region 492 of the setup information storage unit 490, so as to reduce the position deviation of the dummy wafer Wd with respect to the rotary mounting table 322, and then finally decides the corrected transfer position coordinates by storing them.

As described above, in step S114, the transfer position adjustment of the pick A2 with respect to the second load lock chamber 230N (transfer table 232N) and the transfer position adjustment of the pick A1 with respect to the second load lock chamber 230N (transfer table 232N) are completed. Thus, if the wafer W is automatically transferred into the second load lock chamber 230N by the pick A1 or A2 afterwards, the wafer W can be moved and mounted such that its center is aligned substantially coincident with the center of the transfer table 232N.

Subsequently, in step S115, the dummy wafer Wd on the rotary mounting table 322 of the orienter 320 is moved by the pick A2 or A1 (here, the pick A2) onto the transfer table 232M of the first load lock chamber 230M and mounted thereon. Then, the dummy wafer Wd on the transfer table 232M of the first load lock chamber 230M is moved by the pick B2 onto the transfer table 232N of the second load lock chamber 230N and mounted thereon.

Thereafter, the dummy wafer Wd on the transfer table 232N of the second load lock chamber 230N is transferred by the pick A2 into the orienter 320 and is moved onto the rotary mounting table 322 to be mounted thereon. Then, a position deviation amount V and a position deviation direction α of the dummy wafer Wd are detected by the optical sensor 324 while rotating the rotary mounting table 322. Transfer position information data indicating the position deviation amount V and the position deviation direction α detected at this time are transmitted to the control unit 400. Based on the transfer position information data, the control unit 400 corrects the transfer position coordinates of the pick A2 with respect to the second load lock chamber 230N (transfer table 232N), which have been temporarily determined through the above-stated rough teaching operation, so as to reduce the position deviation of the dummy wafer Wd with respect to the rotary mounting table 322, and then finally decides the corrected transfer position coordinates by storing them.

As described above, in step S115, the transfer position adjustment of the pick B2 with respect to the second load lock chamber 230N (transfer table 232-N) is carried out. Thus, if the wafer W is automatically transferred into the second load lock chamber 230N by the pick B2 afterwards, the wafer W can be moved and mounted such that its center is aligned substantially coincident with the center of the transfer table 232N.

By performing the first-step transfer position adjusting process (steps S116 to S115) in the transfer position adjusting process between the common transfer chamber 210 and the orienter 320, the transfer position coordinates of the picks A1, A2, B1 and B2 with respect to the orienter 320 and the first and second load lock chambers 230M and 230N are all determined. As a result, when transferring the wafer W from the orienter 320 by the pick B1 or B2, the pick B1 or B2 can hold the wafer onto the substantially same position regardless of which transfer path is taken, that is, regardless of the combination of the picks A1 and A2 and the first and second load lock chambers 230M and 230N.

Meanwhile, when performing the correction of the transfer position coordinates of the pick B2 with respect to the second load lock chambers 230N (transfer table 232N) in step S115, a transfer position coordinate system in the second load lock chamber 230N (hereinafter, referred to as “second load lock chamber transfer position coordinate system) is utilized. However, the second load lock chamber transfer position coordinate system may not be coincident with an actual coordinate system in the orienter 320 with respect to the second load lock chamber 230N. This phenomenon can occur when, for example, there is an error in the installation of the second load chamber 230N, as in the aforementioned case where the transfer position coordinate system of the processing chamber 220 does not coincide with the actual coordinate system in the orienter 320 with respect to the processing chamber 220. In such case, accurate transfer position adjustment cannot be accomplished, and it is likely that a transfer position deviation in the order of about 1/10 millimeter may be generated in spite of performing the first-step transfer position adjusting process (steps S116 to S115).

Accordingly, to perform the transfer position adjusting process with a higher accuracy in the transfer position adjusting process between the common transfer chamber 210 and the orienter 320 in accordance with the present embodiment, the position deviation correction coordinate system with respect to the second load lock chamber 230N is obtained by actually transferring the dummy wafer Wd after performing the first-step transfer position adjusting process (steps S116 to S115), and the second-step transfer position adjusting process (step S120) for correcting the transfer position coordinates of each of the picks B1 and B2 with respect to the second load lock chamber 230N (transfer table 232N) is performed based on the acquired position deviation correction coordinate system.

(Specific Example of the Second-Step Transfer Position Adjusting Process)

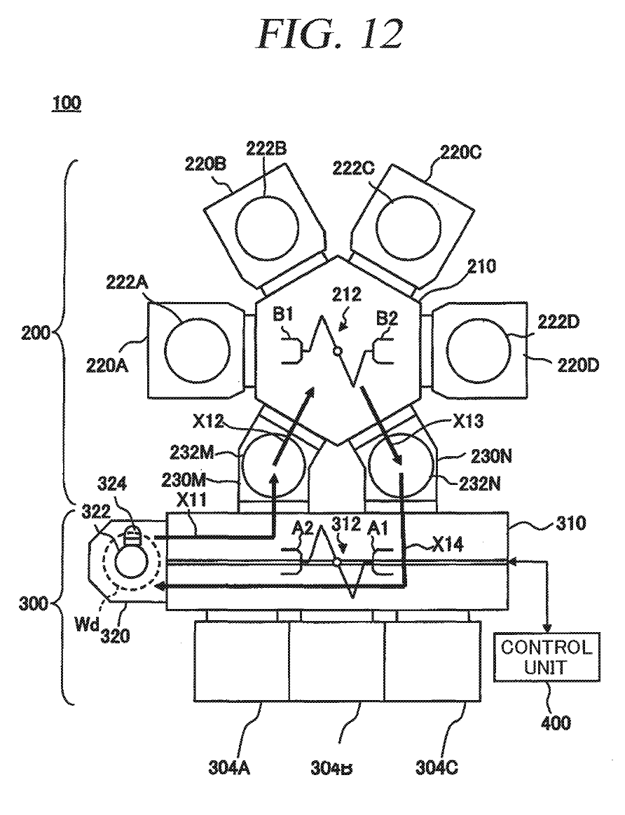

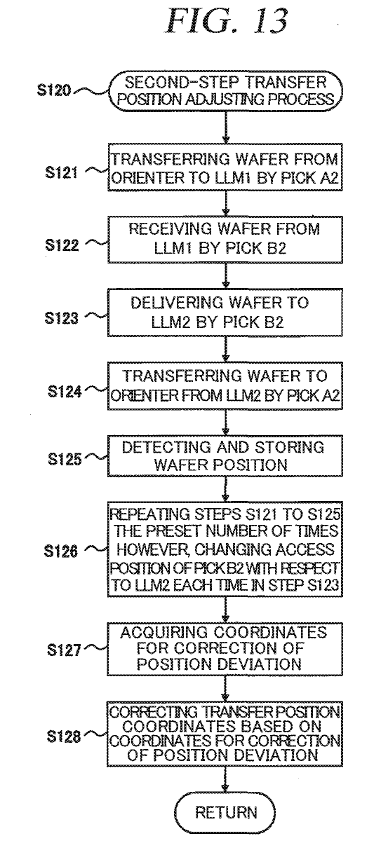

Hereinafter, the second-step transfer position adjusting process in the transfer position adjusting process between the common transfer chamber 210 and the orienter 320 will be explained in conjunction with the accompanying drawings. The second-step transfer position adjusting process aims at aligning the wafer W to be centered on a same position on each of the picks B1 and 82 regardless of which one of the first load lock chamber 230M serving as a reference transit module and the second load lock chamber 230N serving as the other transit module is used to pass the wafer W when the wafer W is transferred from the orienter 320 by the picks B1 and B2 serving as a transfer destination module. FIG. 12 shows a transfer path of the dummy wafer Wd transferred by the transfer system during the second-step transfer position adjusting process. Further, FIG. 13 depicts a flowchart to describe the sequence of the second-step transfer position adjusting process. In FIG. 13, the first and second load lock chambers 230M and 230N are shortly referred to as “LLM1” and “LLM2”, respectively.

First, in step S121, the dummy wafer Wd on the rotary mounting table 322 of the orienter 320 is moved to and mounted on the transfer table 232M of the first load lock chamber 230M by the pick A2 or A1 (here, the pick A2, (transfer path X11).

Subsequently, in step S122, the dummy wafer Wd on the transfer table 232M of the first load lock chamber 230M is received by the pick B2 (transfer path X12).

Thereafter, in step S123, the dummy wafer Wd is moved to and mounted on the transfer table 232N of the second load lock chamber 230N by the pick B2 (transfer path X13). At this time, the pick B2 conveys the dummy wafer wd onto the transfer table 232N of the second load lock chamber 230N by accessing the transfer position coordinates corrected through the first-step transfer position adjusting process (steps S116 to S115).

Then, in step S124, the dummy wafer Wd on the transfer table 232N of the second load lock chamber 230N is transferred by the pick A2 into the orienter 320 and mounted on the rotary mounting table 322 transfer path X14).

Afterwards, in step S125, a position P2 of the dummy wafer Wd is detected by the optical sensor 324 while rotating the rotary mounting table 322. Transfer position information data indicating the position of the dummy wafer Wd detected at this time is transmitted to the control unit The control unit 400 stores the received transfer position information data in the transfer setup information storage region 492 inside the setup information storage unit 490.

Further, in step S126, steps S121 to S125 are repeated a preset number of times. However, in step S123 during step S126, the access position of the pick B2 with respect to the second load lock chamber 230N (transfer table 232N) is changed every time when the dummy wafer Wd is moved by the pick B2 onto the transfer table 232N of the second load lock chamber 230N to mount it thereon.

To be more specific, the access position of the pick B2 is offset by about 0.15 mm from an initial access position in step S123 along the plus direction of the θ axis at a first repetition, and then offset by about 0.30 mm along the same direction at a second repetition, for example. Likewise, the access position of the pick B2 is changed along the minus direction of the θ axis as well. Furthers the access position of the pick B2 is also changed along the plus and minus directions of the R axis from the initial access position in step S123. Accordingly, the repetition number becomes eight in the present embodiment.

In step S125 during step S126, the position of the dummy wafer Wd on the rotary mounting table 322 is detected each time. Transfer position information data indicating each position is sent to the control unit 400. The control unit 400 stores the received transfer position information data in the transfer setup information storage region 492 inside the setup information storage unit 490.

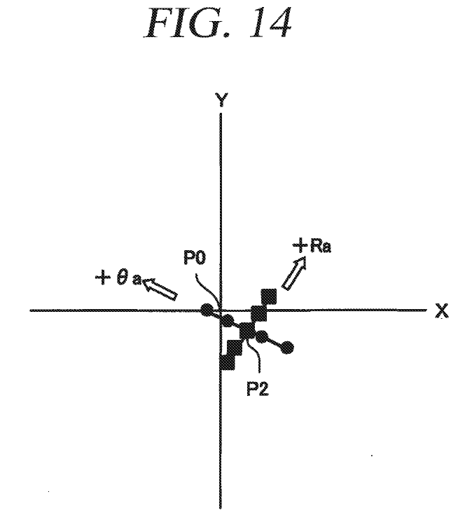

In the present embodiment, since steps S121 to S125 are repeated eight times in step S126, 9 transfer position information data are stored in the transfer setup information storage region 492 including the initially detected transfer position information data in step S125. In subsequent step S127, the control unit 400 reads out these transfer position information data from the setup information storage unit 490 and evaluates the tendency of each transfer position information data for each of the θ-axis direction and the R-axis direction. Specifically, shown in FIG. 14, for example, each transfer position information data is plotted on an orienter coordinate system (XY coordinate system), and an approximate straight-line is obtained for plot points in each of the θ-axis and R-axis directions by using a least squares method or the like. The approximate straight-lines thus obtained are set as a θa axis and a Ra axis, and a coordinate system consisting of the θa axis and the Ra axis is defined as a position deviation correction coordinate system.

Subsequently, in step S128, based on the position deviation correction coordinate system obtained in step S127, the control unit 400 re-determines the transfer position coordinates of the pick B2 with respect to the second load lock chamber 230N (transfer table 232N) which have been determined in the first-step transfer position adjusting process (step S110), as follows.

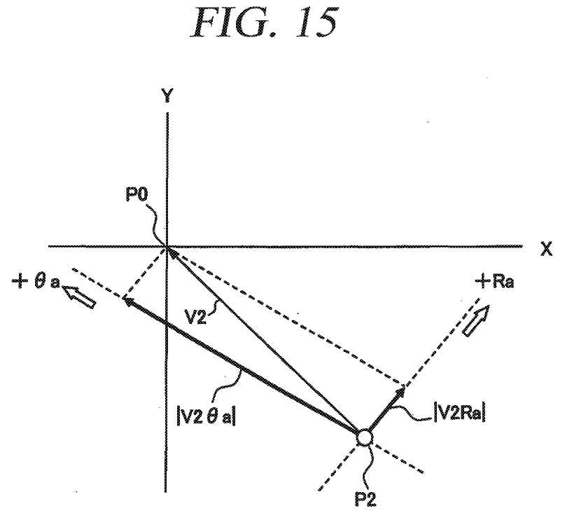

FIG. 15 illustrates a positional relationship between the position P2 of the dummy wafer Wd in the orienter 320 detected in step S125 and the rotation center position P0 of the rotary mounting table 322 of the orienter 320. A vector V2 indicating a position deviation amount and a position deviation direction of the dummy wafer Wd can be decomposed Into an Ra-axis directional vector V2Ra (size |V2Ra|) and a θa-axis directional vector V2θa (size |V2θa|). Accordingly, if the transfer position coordinates of the pick B2 with respect to the second load lock chamber 230N is corrected by an R-axis correction amount |V2Ra| along a minus direction of the Ra axis and by a θ-axis correction amount |V2θa| along a minus direction of the θa axis, P2 becomes coincident with PO. In this case, the Ra-axis correction amount |V2R| can be calculated based on, e.g., a distance between the straight-line ea axis and PO, while the θa-axis correction amount |V2θ| can be calculated based on, e.g., a distance between the straight-line Ra axis and PO.

By performing the second-step transfer position adjusting process (step S120) as described above, the transfer position coordinates of the pick B2 with respect to the second load lock chamber 230N is corrected with a very high level of accuracy, e.g., in the order of about 1/100 millimeter. As a result, when transferring the wafer W from the orienter 320 by the pick B2, the pick B2 is allowed to maintain the wafer W on the same position regardless of which one of the first load lock chamber 230M serving as the reference transit module and the second load lock chamber 230N serving as the other transit module is used to pass the wafer W therethrough.

So far, the second-step transfer position adjusting process for correcting the transfer position coordinates of the pick B2 with respect to the second load lock chamber 230N (transfer table 232N) has been explained. Meanwhile, as for the pick B1, since its position adjustment with respect to the first and second load lock chambers 230M and 230N is performed by the manual manipulations in step S112 of the first-step transfer position adjusting process (step S110), its transfer position coordinates are already determined with a relative high accuracy.

Here, the transfer position coordinates of the pick B1 with respect to the first load lock chamber 230M and with respect to the second load lock chamber 230N are determined individually through separate manual manipulations. Therefore, if there is, for example, an error in the installation of the second load lock chamber 230N, it is highly likely that the positions of the wafer W on the pick B1 may not be identical in two cases where the wafer W is passed through the first load lock chamber 230M and through the second load lock chamber 230N when transferring the wafer W from the orienter 320 to the pick B1. Accordingly, in case of a process requiring a higher level of accuracy, it may be desirable to perform the above-described second-step transfer position adjusting process for the pick B1, as in the case of the pick B2.

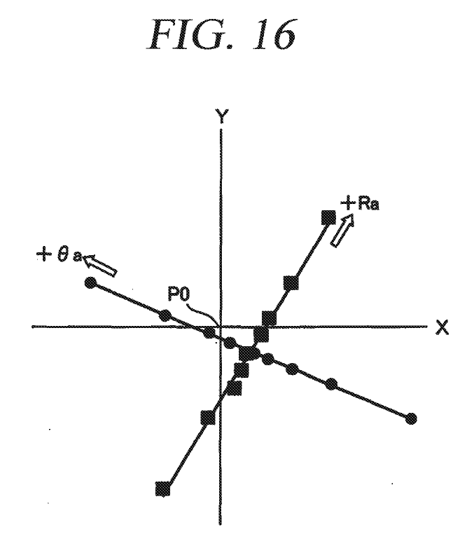

FIG. 16 shows a position deviation correction coordinate system obtained by performing the second-step transfer position adjusting process in FIG. 10 to the pick B1. In this process, every time steps S121 to S125 are repeated in step S126, the pick B1 is made to access positions offset by, e.g., about 0.15 mm, 0.30 mm, 0.60 mm and 1.20 mm along the plus and minus directions of the θ axis and the R axis. Accordingly, the number of repetitions becomes sixteen. As mentioned, by increasing the number of repetitions, the reliability of the obtained position deviation correction coordinate system can be enhanced.

After the position deviation correction coordinate system shown in FIG. 16 is obtained, the transfer position coordinates of the pick B1 with respect to the second load lock chamber 230N (transfer table 232N) which have been determined in the first-step transfer position adjusting process (step S110) is re-determined based on the position deviation correction coordinate system. As a result, when transferring the wafer W from the orienter 320 to the pick B1, the pick B1 is allowed to maintain the wafer W on the same position regardless of which one of the first load lock chamber 230M serving as the reference transit module and the second load lock chamber 230N serving as the other transit module is used to pass the wafer W therethrough.

Moreover, the second-step transfer position adjusting process for the pick B1 may be performed after the completion of the second-step transfer position adjusting process for the pick B2, or can be performed before the second-step transfer adjusting process for the pick B2.

(Transfer Position Adjusting Process Between the Processing Chamber and the Orienter)

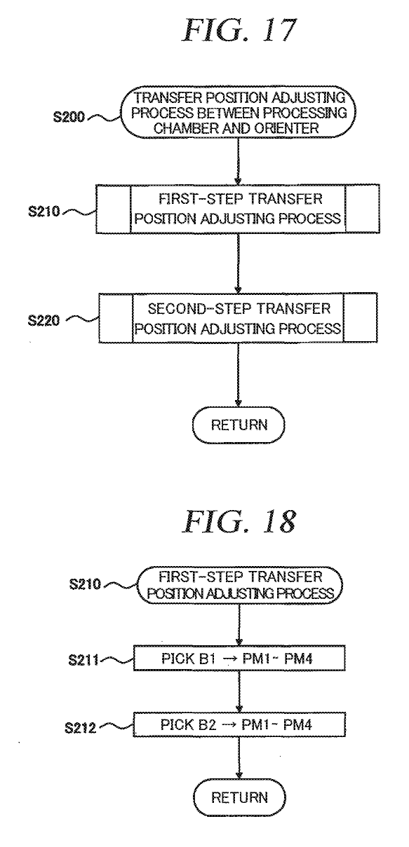

As a result of performing the transfer position adjusting process (step S100) between the common transfer chamber 210 and the orienter 320, the adjustments of the transfer positions from the orienter 320 to the processing unit side transfer device 212 are completed. Thereafter, transfer position adjusting process (step S200) between the processing chamber 220 and the orienter 320 is carried out (see FIG. 9) FIG. 17 shows a sequence of the transfer position adjusting process between the processing chamber 220 and the orienter 320. As illustrated in FIG. 17, the transfer position adjusting process between the processing chamber 220 and the orienter 320 includes a first-step transfer position adjusting process (step S210) and a second-step transfer position adjusting process (step S220).

(First-Step Transfer Position Adjusting Process)

The first-step transfer position adjusting process (step S210) is performed based on, e a flowchart shown in FIG. 18. Further, in FIG. 18 the first to the fourth processing chambers 220A to 220D are shortly referred to as “PM1” to “PM4”.

First, in step S211, position adjustment of the pick (first pick unit) B1 with respect to the first to the fourth processing chambers 220A to 220d is performed. To elaborate, by maintaining the dummy wafer Wd on the pick B1 while aligning it thereon appropriately, the dummy wafer Wd is manually transferred into the first processing chamber 220A and mounted on the mounting table 222A. At this time, the access position of the pick B1 is adjusted to allow the center of the dummy wafer Wd to be coincident with the center of the mounting table 222A. Likewise, the dummy wafer Wd is manually transferred into the second to the fourth processing chambers 220B to 220D as well. The control unit 400 changes the transfer position coordinates of the pick B1 with respect to the first to the fourth processing chambers 220A to 220D (mounting tables 222A to 222D), which have been temporarily determined through the above-state rough teaching operation, into the access position coordinates of the pick B1 at this time, and finally decides the changed transfer position coordinates by storing them.

Next, in step S212, the dummy wafer Wd is mounted on the rotary mounting table 322 of the orienter 320, and is moved to and mounted on the transfer table 232M of the first load lock chamber 230M by the pick A2 or A1 (here, the pick A2). Then, the dummy wafer W on the transfer table 232M of the first load lock chamber 230M is moved to and mounted on the mounting table 222A of the first processing chamber 220A by the pick B1.

Subsequently, the dummy wafer Wd on the mounting table 222A of the first processing chamber 220A is moved to and mounted on the transfer table 232M of the first load lock chamber 230M by the pick (second pick unit) B2. Then, the dummy wafer Wd on the transfer table 232M of the first load lock chamber 230M is transferred by the pick A2 into the orienter 320 and mounted on the rotary mounting table 322. Then, a position deviation amount V and a position deviation direction α of the dummy wafer Wd are detected by the optical sensor 324 while rotating the rotary mounting table 322. Transfer position information data indicating the detected position deviation amount V and the position deviation direction α are transmitted to the control unit 400. Based on the received transfer position information data, the control unit 400 corrects the transfer position coordinates of the pick B2 with respect to the first processing chamber 220A (mounting table 222A), which have been temporarily determined by the above-described rough teaching operation, and then finally decides the corrected transfer position coordinates by storing them, so as to reduce the position deviation of the dummy wafer Wd with respect to the rotary mounting table 322.

Likewise, after transferring the dummy wafer Wd from the orienter 320 to the second to the fourth processing chambers 220B to 220D, the dummy wafer W is returned back into the orienter 320, and a position deviation detecting process is performed therein. Based on the detection results, the control unit 400 corrects the transfer position coordinates of the pick B2 with respect to the second to the fourth processing chambers 220B to 220D (mounting tables 222B to 222D), and finally decides the corrected transfer position coordinates by storing them.

As a result of performing the above-described first-step transfer position adjusting process (steps S211 and S212) in the transfer position adjusting process between the processing chamber 220 and the orienter 320, the transfer position coordinates of the picks B1 and B2 with respect to the first to the fourth processing chambers 220A to 220D are all decided. Further, since the transfer position adjusting process (step S100) between the common transfer chamber 210 and the orienter 320 is performed, the wafer W may be mounted on substantially same positions in the first to the fourth processing chambers 220A to 220D regardless of passing through any transfer path, that is, regardless of the combinations of the picks A1 and A2, the first and second load lock chambers 230M and 230N, and the picks B1 and B2 when the wafer W is transferred from the orienter 320 to the first to the fourth processing chambers 220A to 220D.

However, in spite of performing the above-stated first-step transfer position adjusting process (steps 5211 and S212), there may be generated a transfer position deviation in the order of about 1/10 millimeter. As stated above, there arise occasions that the transfer position coordinate system in each processing chamber 220 are not coincident with the actual coordinate system in the orienter 320 for each processing chamber 220 every time, thereby causing a generation of the transfer position deviation.

Accordingly, in the transfer position adjusting process between the processing chamber 220 and the orienter 320 in accordance with the present embodiment, an actual processing chamber coordinate system is obtained by actually transferring the dummy wafer Wd after performing the first-step transfer position adjusting process (step S210), and the second-step transfer position adjusting process (step S220) for correcting the transfer position coordinates of the pick B2 with respect to the processing chamber 220 (mounting table 222) is performed based on the obtained processing chamber coordinate system.

(Specific Example of the Second-Step Transfer Position Adjusting Process)

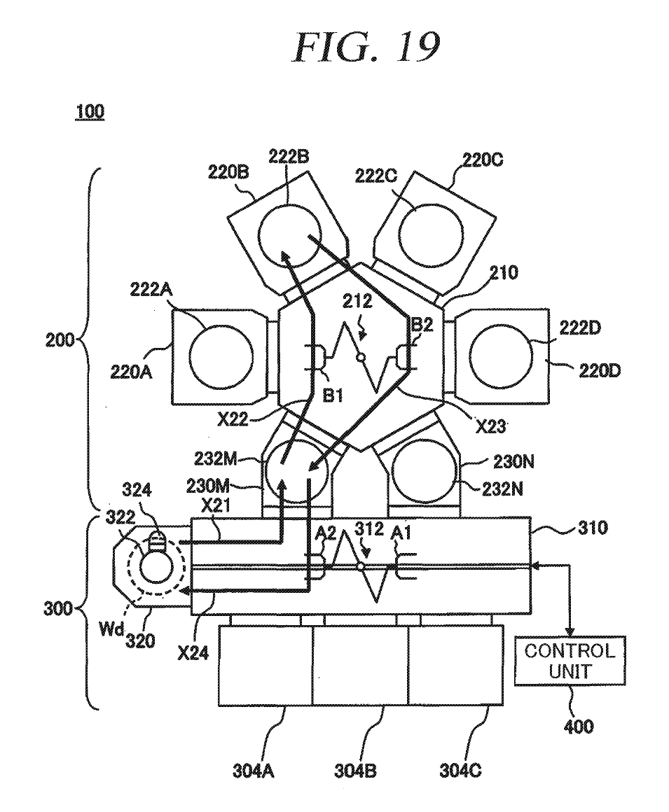

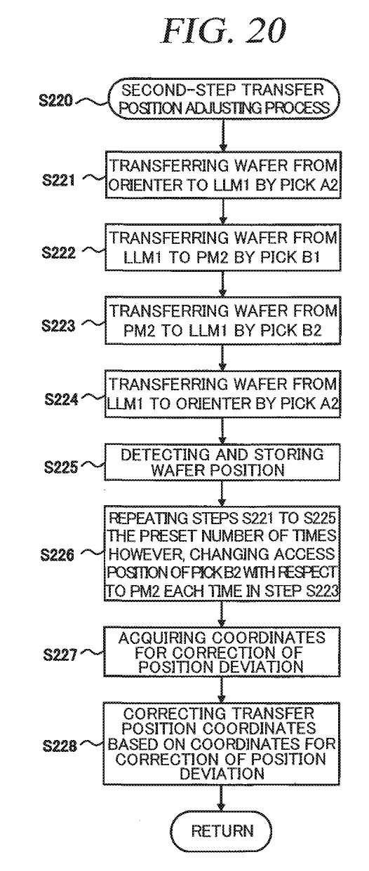

Hereinafter, the second-step transfer position adjusting process in the transfer position adjusting process between the processing chamber 220 and the orienter 320 will be described with reference to the accompanying drawings. The second-step transfer position adjusting process aims at aligning the wafer W to be centered on a same position on the mounting table 222 of the processing chamber 220 regardless of which one of the picks B1 and B2 is used when the wafer W is transferred from the orienter 320 to the processing chamber 220 serving as a transfer destination module. FIG. 19 shows a transfer path of the dummy wafer Wd transferred by the transfer system during the second-step transfer position adjusting process. Further, FIG. 20 depicts a flowchart to describe the sequence of the second-step transfer position adjusting process. In FIG. 20, the first and second load lock chambers 230M and 230N are shortly referred to as “LLM1” and “LLM2”, respectively, and the second processing chamber 220B is shortly referred to as “PM2”.

Moreover, though the second-step transfer position adjusting process (step S220) can be performed for all of the first to the fourth processing chambers 220A to 220D, description will be provided herein only for performing the second-step transfer position adjusting process for the second processing chamber 920B, for example.

First, in step S221, the dummy wafer Wd on the rotary mounting table 322 of the orienter 320 is moved to and mounted on the transfer table 232M of the first load lock chamber 230M by the pick A2 or A1 (here, the pick A2) (transfer path X21).

Subsequently, in step S222, the dummy wafer Wd on the transfer table 232M of the first load lock chamber 230M is received by the pick B1, and moved to and mounted on the mounting table 222B of the second processing chamber 220B (transfer path X22). At this time, the pick B1 conveys the dummy wafer Wd onto the mounting table 222B of the second processing chamber 220B by accessing the transfer position coordinates corrected through the first-step transfer position adjusting process (steps S211 and S212).

Thereafter, in step S223, the dummy wafer Wd on the mounting table 222B of the second processing chamber 220B is moved to and mounted on the transfer table 232M of the first load lock chamber 232M by the pick B2 (transfer path X23).

Subsequently, in step S224, the dummy wafer Wd on the transfer table 232M of the first load lock chamber 230N is transferred by the pick A2 into the orienter 320 and mounted on the rotary mounting table 322 (transfer path X24).

Afterwards, in step S225, a position P3 of the dummy wafer Wd is detected by the optical sensor 324 while rotating the rotary mounting table 322. Transfer position information data indicating the position of the dummy wafer Wd detected at this time is transmitted to the control unit 400. The control unit 400 stores the received transfer position information data in the transfer setup information storage region 492 inside the setup information storage unit 490.

Further, in step S226, steps S221 to S225 are repeated a preset number of times. However, in step S223, the access position of the pick B2 to the second processing chamber 220B (mounting table 222B) is changed every time when the pick B2 receives the dummy wafer Wd from the mounting table 222B of the second processing chamber 220B.

To be more specific, the access position of the pick B2 is offset by about 0.15 mm from an initial access position in step S223 along the plus direction of the θ axis at a first repetition. Thereafter, every time steps S221 to S225 are repeated, the pick B2 is made to access positions offset by about 0.30 mm, 0.60 mm and 1.20 mm, respectively, along the same direction, for example. Likewise, the access position of the pick B2 is changed along the minus direction of the θ axis as well. Further, the access position of the pick B2 is also changed along the plus and minus directions of the R axis from the initial access position in step S223. Accordingly, the repetition number becomes sixteen in the present embodiment.

In step S225 during step S226, the position of the dummy wafer Wd on the rotary mounting table 322 is detected each time. Transfer position information data indicating each position is sent to the control unit 400. The control unit 400 stores the received transfer position information data in the transfer setup information storage region 492 inside the setup information storage unit 490.

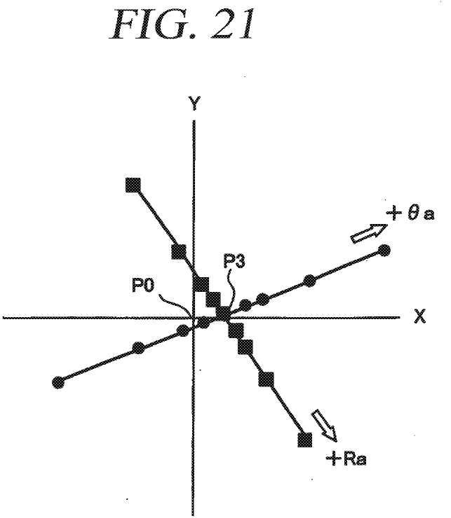

In the present embodiment, since steps S221 to S225 are repeated sixteen times in step S226, 17 transfer position information data are stored in the transfer setup information storage region 492 including the initially detected transfer position information data in step S225. In subsequent step S227, the control unit 400 reads out these transfer position information data from the setup Information storage unit 490 and evaluates the tendency of each transfer position information data for each of the θ-axis direction and the R-axis direction. Specifically, as shown in FIG. 21, for example, each transfer position information data is plotted on an orienter coordinate system (XY coordinate system), and an approximate straight-line is obtained for plot points in each of the θ-axis and R-axis directions by using a least squares method or the like. The approximate straight-lines thus obtained are set as a θa axis and a Ra axis, and a coordinate system consisting of the θa axis and the Ra axis is defined as a position deviation correction coordinate system.

Subsequently, in step S228, based on the position deviation correction coordinate system obtained in step S227, the control unit 400 re-determines the transfer position coordinates of the pick B2 with respect to the second processing chamber 220B (mounting table 222B) which have been determined in the first-step transfer position adjusting process (step S210).

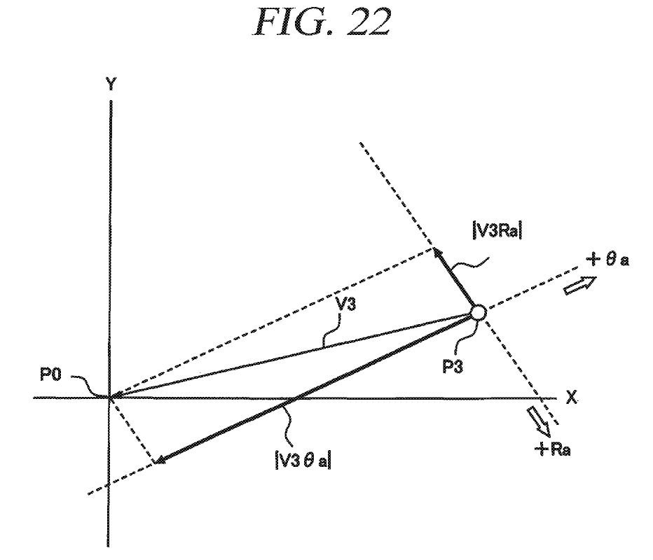

FIG. 22 illustrates a positional relationship between the position P3 of the dummy wafer Wd in the orienter 320 detected in step S225 and the rotation center position P0 of the rotary mounting table 322 of the oriener 320. A vector V3 indicating a position deviation amount and a position deviation direction of the dummy wafer Wd can be decomposed into an Ra-axis directional vector V3Ra (size |V3Ra|) and a θa-axis directional vector V3θa (size |V3θa|). Accordingly, if the transfer position coordinates of the pick B2 with respect to the second transfer chamber 220B is corrected by an R-axis correction amount |V3Ra| along a minus direction of the Ra axis and by a θ-axis correction amount |V3θa| along a minus direction of the θa axis, P3 becomes coincident with PO. In this case, the Ra-axis correction amount |V3R| can be calculated based on, e.g., a distance between the straight-line θa axis and PO, while the θa-axis correction amount |V3θ| can be calculated based on, e.g., a distance between the straight-line Ra axis and PO.

By performing the second-step transfer position adjusting process (step S220) as described above, the transfer position coordinates of the pick B2 with respect to the second processing chamber 220B is corrected with a very high level of accuracy. As a result, when transferring the wafer W from the orienter 320 to the second processing chamber 220B, the wafer W can be placed in the same position on the mounting table 222B of the second processing chamber 220B whichever one of the pick B1 (reference transfer path) and the pick B2 (the other transfer path) is used.

Further, though the present embodiment has been described for the case of second-step transfer position adjusting process for correcting the transfer position coordinates of the pick B2 with respect to the second processing chamber 220B (mounting table 222B), the same process can be also applied to cases of correcting transfer position coordinates of the pick B2 with respect to the first, third and fourth processing chambers 220A, 220C and 220D (mounting tables 222A, 222C and 222D) with a high accuracy.

As described above, according to the transfer position adjusting process in accordance with the present embodiment, the position deviation correction coordinate system is acquired in the second-step transfer position adjusting process (steps S120 and S220) based on the transfer position information obtained by actually transferring the dummy wafer Wd. Therefore, the obtained position deviation correction coordinate system accurately reflects the assembly state of the substrate processing apparatus 100, and the like. Further, in the second-step transfer position adjusting process, the transfer position is corrected based on this position deviation correction coordinate system. Accordingly, even in case the installation position or installation angle of the processing chamber 220 becomes different from original designs, the transfer position in the processing chamber 220 through the transfer path (the other transfer path) of the pick B2 can be corrected to be coincident with the transfer position through the transfer path (the reference transfer path) of the pick B1 with a high level of accuracy. For example, an accuracy level in the order of about 1/100 millimeter can be obtained. As a result, whichever transfer path is taken, the wafer W can be transferred to the same position very accurately.

Moreover, the embodiment of the present invention has been described for correcting the transfer positions in each processing chamber 220 and the second load lock chamber 230N. Likewise, the present invention can be also applied to correcting transfer positions of the common transfer chamber 210, each cassette vessel 302, and so forth with a higher accuracy.

In addition, in the present embodiment, though the position deviation amount V and the position deviation direction α of the dummy wafer Wd in the orienter 320 are detected by repeating the transfer of the dummy wafer Wd seventeen times so as to obtain the position deviation correction coordinate system, the repetition number is not limited thereto. The θ axis and the R axis can be obtained by repeating the transfer at least two times along each of the θ and R directions, and the reliability of the obtained position deviation correction coordinate system can be improved as the repetition number increases. Furthermore, assuming that the obtained position deviation correction coordinate system is a rectangular coordinate system, it may be possible to determine either one of the θ axis and the R axis by measurement and to determine the other axis by calculation.

While the invention has been described with respect to the embodiment with reference to the accompanying drawings, the present invention is not limited thereto, and it would be understood by those skilled in the art that various changes and modifications may be made without departing from the scope of the invention as defined in the following claims. It shall be understood that all modifications and changes conceived from the meaning and scope of the claims and their equivalents are included in the scope of the present invention.

For example, though the above embodiment has been described for the so-called cluster-tool type substrate processing apparatus including the plurality of processing chambers 220A to 220D disposed around and connected to the common transfer chamber 210, the present invention can also be applied to, e.g., a so-called tandem-type substrate processing apparatus including a plurality of processing chambers connected to a transfer unit in parallel.

### INDUSTRIAL APPLICABILITY

The present invention has many advantages when it is applied to a transfer position adjusting method of a transfer system installed in a substrate processing apparatus or the like.

1. A transfer position adjusting method in a transfer system including: a position adjusting device for detecting a position deviation of a target object to be transferred; and a module capable of receiving the target object loaded thereinto,
the transfer system being capable of transferring the target object to preset transfer positions of the position adjusting device and the module through a plurality of transfer paths,
the method adjusting, when one of the plurality of transfer paths is set as a reference transfer path, a position transferred along the other transfer path to a position transferred along the reference transfer path in the module,
the method comprising:
detecting a position deviation of a position adjusting target object to be transferred, after returning it back from the module to the position adjusting device through the other transfer path, from a position where the position adjusting target object was placed before transferring it from the position adjusting device to the module through the reference transfer path;
detecting a position deviation of the position adjusting target object after transferring it, which has been shifted from a transfer position in the module by a predetermined shift amount along a direction in which a correction of the position deviation can be made, up to the position adjusting device from the module through the other transfer path, and obtaining a coordinate system for correcting the position deviation by calculating a position deviation direction of a transfer position in the position adjusting device corresponding to a direction along which the correction of the transfer position deviation in the module is possible based on a multiplicity of position deviation detection results obtained by repeating the detection of the position deviation several times while varying the shift amount; and
correcting the transfer position in the module by the other transfer path based on the coordinate system for correcting the position deviation so as to reduce the detected position deviation.

2. The method of claim 1, wherein the transfer system includes a transfer device having a number of picks for holding the target object, and each of the plurality of transfer paths is a transfer path along which the target object is transferred by a different pick of the transfer device.

3. The method of claim 1, wherein the module is one of a processing module for performing a preset process on the loaded target object; a transit module for transiting the target object when the target object is transferred to the processing module; a transfer module having a transfer device accessible to the processing module; and an accommodation module for accommodating the target object.

4. A transfer position adjusting method in a transfer system including: a position adjusting device for detecting a position deviation of a target object to be transferred; and a plurality of transit modules for transiting the target object when transferring the target object to a preset transfer position,
the method adjusting, when one of the plurality of transit modules is set as a reference transit module, a position transferred along a transfer path passing through the other transit module to a position transferred along a transfer path passing through the reference transit module,
the method comprising:
detecting a position deviation of a position adjusting target object to be transferred, after returning it back from the preset transfer position into the position adjusting device through the transfer path passing through the other transit module, from a position where the position adjusting target object was placed before transferring it from the position adjusting device to the preset transfer position through the transfer path passing through the reference transit module;
obtaining a coordinate system for correcting the position deviation by calculating a position deviation direction of a transfer position in the position adjusting device corresponding to a direction along which the correction of the position deviation of the transfer position in the other transit module can be made when the target object is transferred between the position adjusting device and the preset transfer position through the transfer path passing through the other transit module; and
correcting the transfer position in the other transit module based on the coordinate system for correcting the position deviation so as to reduce the detected position deviation.

5. A transfer position adjusting method in a transfer system including: a position adjusting device for detecting a position deviation of a target object to be transferred; at least one processing module for performing a predetermined process on the target object loaded thereinto; at least one transit module for transiting the target object when the target object is transferred to the processing module; a first transfer device, having at least one pick unit for holding the target object, accessible to the position adjusting device and the transit module; and a second transfer device, having a first and a second pick unit for holding the target object, accessible to the transit module and the processing module,
when among a plurality of transfer paths for the target object available between the position adjusting device and the processing module, a transfer path passing through the pick unit of the first transfer device, the transit module and the first pick unit of the second transfer device is set as a reference transfer path and a transfer path passing through the pick unit of the first transfer device, the transit module and the second pick unit of the second transfer device is set as the other transfer path,
the method adjusting a position transferred along the other transfer path to a position transferred along the reference transfer path in the processing module,
the method comprising:
detecting a position deviation of a position adjusting target object to be transferred, after returning it back from the processing module into the position adjusting device through the other transfer path, from a position where the position adjusting target object was placed before transferring it from the position adjusting device to the processing module through the reference transfer path;
transferring the position adjusting target object, which was transferred to the processing module from the position adjusting device through the reference transfer path, to the second pick unit of the second transfer device by shifting the position adjusting target object from the transfer position in the processing module by a predetermined shift amount along a direction in which a correction of the position deviation can be made; detecting a position deviation of the position adjusting target object after returning the position adjusting target object to the position adjusting device through the other transfer path, and obtaining a coordinate system for correcting the position deviation by calculating a position deviation direction of the transfer position in the position adjusting device corresponding to a direction along which the correction of the position deviation of the transfer position in the processing module can be made based on a multiplicity of position deviation detection results obtained by repeating the detection of the position deviation several times while varying the shift amount; and
correcting the transfer position in the processing module by the other transfer path based on the coordinate system for correcting the position deviation so as to reduce the detected position deviation.

6. The method of claim 5, wherein the direction along which the correction of a position deviation of the second pick unit of the second transfer device with respect to the processing module can be made is a loading direction of the second pick unit of the second transfer device into the processing module or a direction perpendicular to the loading direction.

7. The method of claim 5, wherein in case that the transfer system includes a plurality of processing modules, the process of detecting the position deviation of the position adjusting target object before and after the transfer thereof, the process of obtaining the coordinate system for the correction of the position deviation, and the process of correcting the transfer position in the processing module are performed for each of the plurality of processing modules.

8. A transfer position adjusting method in a transfer system including: a position adjusting device for detecting a position deviation of a target object to be transferred; at least one processing module for performing a predetermined process on the target object loaded thereinto; a first and a second transit module for transiting the target object when the target object is transferred to the processing module; a first transfer device, having at least one pick unit for holding the target object, accessible to the position adjusting device and each of the transit modules; and a second transfer device, having at least one pick unit for holding the target object, accessible to each of the transit modules and the processing module,
when among a plurality of transfer paths for the target object available between the position adjusting device and the pick unit of the second transfer device, a transfer path passing through the pick unit of the first transfer device and the first transit module is set as a reference transfer path and a transfer path passing through the pick unit of the first transfer device and the second transit module is set as the other transfer path,
the method adjusting a position transferred along the other transfer path to a position transferred along the reference transfer path on the pick unit of the second transfer device,
the method comprising:
detecting a position deviation of a position adjusting target object to be transferred, after returning it back from the pick unit of the second transfer device into the position adjusting device through the other transfer path, from a position where the position adjusting target object was placed before transferring it from the position adjusting device to the second pick unit of the second transfer device through the reference transfer path;
mounting the position adjusting target object, which was transferred up to the pick unit of the second transfer device from the position adjusting device through the reference transfer path, in the second transit module by shifting the position adjusting target object from the transfer position on the pick unit of the second transfer device by a predetermined shift amount along a direction in which a correction of the position deviation can be made; detecting a position deviation of the position adjusting target object after returning the position adjusting target object to the position adjusting device from the second transit module through the other transfer path, and obtaining a coordinate system for correcting the position deviation by calculating a position deviation direction of the transfer position in the position adjusting device corresponding to a direction along which the correction of the position deviation on the pick unit of the second transfer device can be made based on a multiplicity of position deviation detection results obtained by repeating the detection of the position deviation several times while varying the shift amount; and
correcting the transfer position on the pick unit of the second transfer device by the other transfer path based on the coordinate system for correcting the position deviation so as to reduce the detected position deviation.

9. The method of claim 8, wherein the direction along which the correction of a position deviation of the pick unit of the second transfer device with respect to the second transit module is a loading direction of the pick unit of the second transfer device into the second transit module or a direction perpendicular to the loading direction.

10. The method of claim 8, wherein in case that the second transfer device includes a plurality of pick units, the process of detecting the position deviation of the position adjusting target object before and after the transfer thereof, the process of obtaining the coordinate system for correcting the position deviation, and the process of correcting the transfer position on the pick unit of the second transfer device are performed for each of the plurality of pick units of the second transfer device.
